(19) United States
(12) Patent Application Publication
(10) Pub. No.: US 2022/0112115 A1
(43) Pub. Date: Apr. 14, 2022

(54) Laminated Glass Tubes and Their Manufacture

(71) Applicant: Anatoly Kishinevski, Holyoke, MA (US)

(72) Inventor: Anatoly Kishinevski, Holyoke, MA (US)

(21) Appl. No.: 17/501,425

(22) Filed: Oct. 14, 2021

Related U.S. Application Data
(60) Provisional application No. 63/091,320, filed on Oct. 14, 2020.

(51) Int. Cl. C03B 23/057; C03B 23/045; C03B 23/13; B32B 1/08

(52) U.S. Cl. CPC C03B 23/057; B32B 1/08; C03B 23/13; C03B 23/045

(57) ABSTRACT

A glass tube is manufactured by a method in which a smaller tube is within a larger tube. A space which is formed between the smaller and larger tube is filled with colored, patterned, or clear glass rods or bars to form an assembly. On one end of the assembly, the inner tube is sealed to the outer tube, on an opposite end of the assembly, the inner tube being closed. The assembly is attached to a linear slide mechanism. The linear slide mechanism is used to pass the assembly through a high-temperature furnace having a temperature above the glass transition temperature of the glasses used to build the assembly. A vacuum is applied to the assembly, causing the glasses to collapse towards each other once they reach a plastic state, and causing the outer tube and inner tube to seal against the colored, patterned, or clear glass rods or bars that were held captive.

### TECHNICAL FIELD

The present invention pertains to laminated glass tubes, and their manufacture, and more specifically to colored low-thermal-expansion borosilicate glass tubes and their manufacture.

### BACKGROUND

In the glass art industry, particularly within the torch working (also known as lampworking) field of glass blowing, glass which is in the form of a tube (hollow cylinder) is a common starting geometry for the creative process. Much like the paints, paint brush and canvas of a painter, glass artists use colored and clear glass tubes and colored and clear glass rods, and a high-temperature flame from a torch (utilizing fuel-air or fuel-oxygen) to accomplish their creative process. The glass tubes and rods used by a glass artist are available in different colors, translucent hues and clear.

Colored low-thermal-expansion borosilicate glass in rod form is abundantly available and can be purchased easily in a wide variety of colors by anyone. Colored low-thermal-expansion borosilicate glass in tube form is not abundantly available, with supply and production of this material being limited in volume and technological development.

The supply of glass in rod form (solid cylinder) to the glass art industry is well matured, and glass rods (industry standard diameter is approximately 7 mm for color rods) of many colors and clear can be purchased easily. The ample supply of glass rods to the glass art industry is a result of the manufacturing process being mechanized and perfected by suppliers, resulting in efficiency and ease in repeatability. A mechanism to draw glass or extrude glass in rod form from a reservoir (such as a crucible) of molten glass is not technically complex, and can be designed and manufactured with minimal technical and monetary investment. Manufacturing glass in rod form is achievable by any company or entity with minimal investment of resources.

Glass in tubing form falls into several categories with varying degrees of commercial availability, methods of manufacture, and intended application of use.

The first category of glass tubing is clear glass tubing that is manufactured in industrial settings in very large commercial volumes (1,000s-1,000,000s of tons per year). This clear tubing is made to precise dimensions (outer diameter, wall weight and circularity are precisely controlled). Manufacturing of clear tubing is executed by roughly a dozen companies globally and occurs in China, Czech Republic, United States, Germany, and Russia as a few examples. The most common industrial methods of manufacture of clear tubing include the Danner Process, Vello Process, and Updraw Process. Clear tubing is produced out of numerous glass types including medium-thermal-expansion borosilicate glasses for pharmaceutical applications, high-thermal-expansion glasses such as soda lime glass for art and technical applications (neon and glass-to-metal sealing), aluminosilicate tubing which is used for halogen lamps and other applications where gas permeability by the glass is not acceptable, and low-thermal-expansion borosilicate glass (Pyrex, Duran, Simax, 33 expansion glass), which is the primary type used by glass artists and scientific glassblowers. Glass in this first category is produced in highly refined manufacturing environments (factories), which require significant capital investment ($100s K-$billions USD) to build. Typically, the processes used in these commercial scale tubing factories are the result of many decades of progressive research and developmental effort. The hardware and equipment used in these factories is state-of-the-art and is highly technically developed. Glass in this category is available in a wide range of sizes from less than 1 mm in diameter to over 300 mm in diameter. Glass in this category is available for purchases easily by anyone and in large volumes.

A second category of tubing is that of “Asian” colored low-thermal-expansion borosilicate glass tubing. This glass is manufactured for use by glass artists and comes in several dozen colors. It is typically low cost allowing a glass artist to acquire a large quantity of glass tubing at affordable prices. This glass is considered 2^{nd} quality and is inferior in many aspects to the first category of glass described. It is typically referred to in conversation between artists as “China Glass” or “Asian Glass.” The dimensional control of “Asian Glass” tubing is of moderate precision and tubes are often bowed (curved significantly) or may be oval in cross-sectional geometry while circular is what is intended by the manufacturer. The thickness of the tubing walls can be inconsistent. The refined quality of the glass is often fair to poor with refractory stone inclusions, air lines, and bubbles occurring frequently enough that it can be problematic for the user of the material. Critical properties of “Asian Glass” for use in glass art, such as thermal expansion coefficient, annealing temperature, and softening temperature are not uniform from one color to the next, often rendering the glass to be incompatible or unusable where a first quality colored low-thermal-expansion borosilicate glass would typically be used with no problems (deep encasement of the colored glass in clear glass such as in manufacturing of marbles, or sealing with other colors). This category of glass, “Asian Glass,” is used quite a bit by glass artists where they need colored tubing that is just good enough to get the job done, but quality is not a first priority. This category of tubing exists in limited colors. The colors that are available are mostly traditional glass colors such as cobalt or copper blues, copper/bismuth reds, copper or chrome/iron greens, and other simple glass color chemistries that have been established decades or even centuries ago and that are easily transferrable to the base chemical composition of low-thermal-expansion borosilicate glass. However, more exotic and/or chemically complicated colors are beginning to emerge from the Asian suppliers as they have begun to reverse engineer glass color chemistries of United States manufacturers' low-thermal-expansion borosilicate glass.

A third category of glass tubing is that of hand-pulled colored low-thermal-expansion borosilicate glass tubing (low-thermal-expansion, 33 expansion glass). This glass is very labor intensive to produce and is manufactured with the intended purpose being for use by glass artists. It is very expensive to purchase by the end user. The glass tubes are literally pulled by hand through the careful choreography of two or more individuals that stretch a large bubble of hot molten glass into a long tube.

At this time in the world, the primary glass type used by glass artists (lampworkers, also known as torch workers) are colored low-thermal-expansion borosilicate glasses and clear low-thermal-expansion borosilicate glass (common trade names for the clear glass are Pyrex, SCHOTT Duran, Simax or generally 33 expansion glass). The glass art industry is intimately entangled with the swiftly developing cannabis industry as legalization of marijuana is happening rapidly across the United States. A primary or common product of glass artists efforts are glass pipes that are used by members of the cannabis industry. There is very significant money in the cannabis industry which is directed to the glass industry via purchase of handmade glass pipes. The handmade glass pipes often sell for hundreds or many thousands of dollars. The demand for glass art (including pipes and other wares) is significant and the demand for raw materials and supplies to make glass art is proportionally significant and also increasing.

The majority of colored low-thermal-expansion borosilicate glasses used by glass artists are manufactured by one of several small companies in the United States which use primitive processes (by industrial glass manufacturing standards). The process of coloring low-thermal-expansion borosilicate glass is a relatively new field of glass chemistry which began gaining significant interest in the late 1990's. It is not always possible to apply glass color chemistries of more developed glass types such as soda lime glass directly to low-thermal-expansion borosilicate glass. In some situations, the color chemistry can be directly transferred such as with a cobalt blue; however, for many colors, what works in soda lime glass does not work in low-thermal-expansion borosilicate glass.

Domestic manufacturers of colored low-thermal-expansion borosilicate glass are in a state of constant research and development as they are discovering new colors and refining already existing colors. Many of the colored low-thermal-expansion borosilicate glasses and color effects (sparkles in glass by carefully grown metallic crystals) that have been discovered and/or refined over the past three decades are stunning in their visual effect. The compositions and color chemistries of these new glasses, which are highly innovative and created through exhaustive efforts by the manufacturers, are carefully guarded and treated as proprietary. The “Asian Glass” company(s) have been slowly reverse engineering these compositions and making attempts to produce them at lower cost.

United States production of colored low-thermal-expansion borosilicate glasses typically happens in small volumes of less than 500 lbs. for each color. Each melt of glass is done in a crucible that is less than 80 liters in volume. The crucible sits in an electrically heated oven and is heated to a temperature high enough to melt the glass. The crucible is filled with clear low-thermal-expansion borosilicate glass and different metals and metal oxide are added to the clear glass to color it (the clear glass is doped to make color). When the glass has been melted for long enough and is in a refined sate, it is extracted from the crucible either by pulling a rod continuously using a simple tractor mechanism, or by dipping an already formed tube in the glass to make a thicker tube (large, elongated bubble with a handle), and then stretching it to make a long piece of tubing. The manufacturing process is low technology.

Production of glass tubing made out of these domestically produced colored low-thermal-expansion borosilicate glasses is typically accomplished by hand pulling tubing. A clear glass tube (readily commercially available) or a color glass tube is closed on one end by conventional glassblowing process to render what is effectively a large test tube. The closed end of the tube is dipped (by hand) into a crucible of molten colored low-thermal-expansion borosilicate glass rendering a tube with a thick coating of molten colored glass on the outside. The heat of the molten glass which is coating the tube softens and melts the tube within. The very tip of the closed end is secured in some type of handheld clamp such as a glassblower's diamond sheers and a person pulls that end in one direction while a second person pulls in an opposing direction, stretching the glass to several times its length at the beginning of the stretch. (It is common for the person on the open end of the tube to blow during stretching to prevent the diameter of the formed tube from reducing too much.) This stretching process is done vertically, as attempting this process horizontally would result in the glass drooping and it is not practical for the humans that are doing the stretching to rotate the glass effectively to prevent it from drooping uncontrollably towards earth, per the effect of gravity. A ladder, staircase. or hydraulic lift may be employed so that the person on the top end of the stretching process is able to travel far enough from the other participant in the process. The product of this stretching is a long thick tube with colored glass on the outside and thin layer of clear (or color if a color tube was used at the beginning) on the inside. The typical length of a tube pull of this sort is around 2-3 meters with an approximate diameter of approximately 18-40 mm. The hand-pulled tubing is inconsistent in diameter and wall weight and it is impossible to have perfect repeatability. The dimensional repeatability of glass made by this process is low. The glass can be grouped in a similar size range (diameter and wall thickness), but none of it will be identical. The hand pulling process is labor intensive and lacks precision and repeatability, which render various commercial challenges. It can be difficult to cut and section a hand-pulled tube and inventory it for sale when each piece is a different size and weight. Also, the end user (the glass artist) would typically greatly prefer to have a tube that is consistent and predictable in its wall thickness as when the wall of a tube is too thick it makes working with the glass more difficult and takes more time.

Manufactures of colored low-thermal-expansion borosilicate glass would benefit greatly from a method to make tubing out of their colored glasses, which would be more repeatable and less labor intensive than the hand pulling process currently used. The reason no tube drawing machine or automated process (such as what is used in the first mentioned category of glass tubing) is implemented could be because such an investment is beyond the technical and monetary resources of the domestic manufacturers of colored low-thermal-expansion borosilicate glass.

Small manufacturers of technical glasses (optical glasses, acid soluble glasses, glasses with special electrical properties, etc.) also wish to produce tubing of the glasses they manufacture, but they face a similar challenge as the colored low-thermal-expansion borosilicate glass manufacturers. The challenges can include the required investment both of technical resource and money being beyond what is feasible or justifiable (return on investment for such equipment may not be possible or have a large enough profit margin) for them. The manufacturers of technical glasses have figured out a way to extrude tubes of short lengths which gives them what they need, but the extrusion process is difficult to adapt to the colored low-thermal-expansion borosilicate glasses because the colored low-thermal-expansion borosilicate glasses require much higher temperatures to process and the extrusion equipment must be adapted accordingly. It quickly becomes an expensive and challenging engineering project to extrude color low-thermal-expansion borosilicate glass.

Kishinev ski et al., U.S. Patent Publication 2018/0244558, describes use of a draw tower in the manufacture of glass canes, but not glass tubing. A glass cane is manufactured by filling a glass tube with a combination of glass structures forming a cross-sectional pattern within the glass tube, to form a preform. The preform is attached to a draw tower. The draw tower is operated to draw the preform to a reduced-diameter glass cane by passing the preform through a furnace of the draw tower while pulling the preform and rotating the preform.

### SUMMARY

It is an object of the invention to provide a mechanized process for producing glass tubing for the glass art community or for special technical or optical applications.

According to the invention, a colored glass tube, waveguide or optical component is manufactured by nesting a smaller glass tube within a larger glass tube leaving a space between the two, intentionally. A layer or ring of colored, patterned or clear glass rods or bars is created by inserting the rods or bars into the space in between the outer tube and inner tube. Upon initial insertion of the colored, patterned, or clear glass rods or bars into the interstitial volume between the inner and outer tube, they are not sealed together, but are just constrained next to each other.

On one end of the assemblage of the tubes and colored, patterned, or clear glass rods or bars contained within, the inner clear tube (or a color tube may be used instead of clear) is sealed closed (typically to a round or semispherical shape) by means of a traditional glassblowing technique. On the opposing end of the assembly, the inner tube is sealed to the outer tube, creating a seal that is restrictive to the flow of gas or completely hermetically sealed. When such a seal is executed between a smaller and larger tube by means of glass blowing technique (using a high-temperature focused flame) and the smaller inner tube remains approximately concentric to the outer tube, it is classically referred to as a Dewar seal. Such a seal is employed in glass thermoses and cryostats. A thermos is a classic example of a Dewar seal.

The assembly as just described, composed of a smaller and larger glass tube with a ring or layer of glass rods or bars placed in between, the inner tube being sealed closed on one end and the inner and outer glass tubes being sealed together on the opposing end creating a Dewar seal, will be referred to as a “preform” from here forward.

The preform is attached to a machine, such as a draw tower, which can raise or lower the preform vertically at a controlled rate. The draw tower is operated to pass the preform through a high-temperature furnace of the draw tower while pulling vacuum on the preform, evacuating the volume in between the outer tube and inner tube, in which the glass rods or bars are contained within. As the preform is passed into the high-temperature furnace, per the nature of glass when it is heated above the glass transition temperature, the inner and outer tubes, and the rods and bars contained within, achieve a state of plasticity and collapse towards each other, sealing the rods or bars of glass in between to each other and the inner and outer tubes, rendering a laminated glass tube.

The effect of the inner and outer glass tubes collapsing towards each other while heated under vacuum is that the glass rods or bars, which were installed in between the inner and outer glass tubes at the time the preform was assembled, are constrained and fused together and are permanently laminated by the inner and outer tubes, yielding a single piece of glass in tube form. The glass tube produced by the method has dimensional uniformity as perceived visually throughout the glass tube.

While the preform is lowered into the high-temperature furnace at a controlled rate, there is a stage or pedestal that is supporting the bottom of the preform, preventing the glass from free falling by the effect of the force of gravity, as it is heated to a plastic state in the high-temperature furnace. The stage or pedestal is mounted on a long rod or pole and is lowered at a controlled rate, supporting and allowing the glass which is heated in the high-temperature furnace to exit the high-temperature furnace at a controlled rate, instead of free falling. The stage or pedestal that controls the descent of the glass out of the high-temperature furnace may have a finger protruding from it which extends into the bottom of the preform and formed tube. The pedestal or stage may also be raised or lowered by any other means which achieves the precise control necessary to lower the glass at a controlled rate. The stage or pedestal may be flat or cup shaped. In the configuration in which the stage or pedestal is mounted to a long rod or pole, the rod or pole may be hollow, allowing for the introduction or exhaust of air or gasses which may be utilized for expanding or constricting the laminated tube as it is formed. The stage may also be pneumatic such that the bottom of the tube exiting the furnace feeds into a cylinder which is pressurized in a controlled manner allowing a controlled descent of the glass tube into the cylinder.

The pedestal which receives and supports the glass as it exits the high-temperature furnace may move at a rate equal to or greater than the rate that the preform is fed into the high-temperature furnace. If the pedestal, which is supporting the glass as it is heated in the furnace, is lowered at a rate greater than the rate that the glass is being fed into the furnace, there will be an attenuation of the diameter of the formed tube. The pedestal may be lowered at a rate greater than the rate the preform is fed into the high-temperature furnace with the intended result being that of making a smaller diameter final tube.

In certain embodiments, the preform may be raised upward through the furnace and the pedestal or platform supporting the bottom of the preform also moves upward, essentially executing the aforementioned process in a reverse direction. In such an embodiment, the supporting pedestal or platform at the bottom of the preform would move at a rate equal to or less than the rate that the preform is raised through the furnace. In this configuration the top of the preform would be consolidated and fused into a tube first and the laminating process would progress downward, the length of the preform.

In certain embodiments the preform may be rotated at a controlled rate while it is lowered or raised into the high-temperature furnace. The stage or pedestal only moves vertically and is not rotated and resists rotating, holding the end of the preform stationary, and the result is a glass tube that has intentional twisting around its perimeter, like the twists on a candy cane or the twists of a barber shop pole. Such twisting may serve only aesthetic purposes, but may also have an optical function such as achieving certain wave guiding properties and behavior in the final formed tube. Alternatively, the receiving pedestal may rotate while the preform does not rotate, to induce a twisting effect similar to or the same as if the preform is twisted while it is lowered into the high-temperature electric furnace.

The glass rods or bars inserted within the interstitial volume between the inner and outer glass tube may include a combination of glasses of differing colors, glasses with patterns or twists, glasses with specific optical properties, chemical properties such as acid being acid or water soluble, and may further include clear glass. Patterned glass rods may mean twisted glass canes (Zanfirico glass, latticino, filigree, filigrana, etc.) or glass rods or bars that have been colored or patterned (painted, silk screened, etc.) with enamel or though alternative techniques.

In certain embodiments the preform is attached to the draw tower vertically and the preform is drawn in a vertical direction. The step of attaching the preform to the draw assembly may include connecting an open end of the preform with a vacuum source, and the step of operating the draw tower may include operating the vacuum pump while performing the step of passing the preform through the high-temperature furnace while a receiving pedestal controls the output rate of the glass from the furnace and prevents it from free falling per the force of gravity. The step of connecting the open end of the preform with a vacuum source may include attaching the open end to a reduction fitting having a connector for connecting with the vacuum source. A coupling may be secured around the preform and the reduction fitting so that at least a partial hermetic seal is formed between the preform and the reduction fitting.

In certain embodiments, the glass tube yielded from this process may contain or be made of acid or water-soluble glasses or generally glasses with poor chemical durability which can be later removed by a wet chemical etching process.

In certain embodiments, the glass tube yielded from this process may contain or be made of high or low-index optical glasses yielding a component or final product that may be used for guiding light (fiber optics) or for manufacturing optical fibers or waveguides by means of a subsequent drawing process, such as incorporating a high or low-index-of-refraction core bar and redrawing.

In certain embodiments the preform may be passed through a high-temperature furnace and the fusing process of the outer and inner tubes with the glass rods or bars in between happens in a progressive manner, gradually from one end of the preform to the other.

In certain embodiments the pedestal receiving and supporting the preform as it is exiting or entering the high-temperature furnace may have a cup geometry or tapered cone and contain the end of the preform instead of the preform simply resting on top of the pedestal or stage.

In certain embodiments the pedestal or cup, receiving and supporting the preform as it is exiting or entering the high-temperature furnace, may be mounted to a pole or rod which is hollow, allowing for gas to be fed into the internal volume of the preform during heating, resulting in a controlled expansion of the preform.

In certain embodiments the pedestal or cup, receiving and supporting the preform as it is exiting or entering the high-temperature furnace, may be mounted to a pole or rod which is hollow, allowing for gas to be removed from the internal volume of the preform during heating, resulting in a controlled contraction or collapse of the preform.

In certain embodiments the preform may be placed entirely into a high-temperature furnace or oven and the fusing process of the outer and inner tubes, with the glass rods or bars in between, happens to the whole length of the preform at one time.

In certain embodiments, a ring of colored, patterned or clear glass rods or bars is created by inserting the rods or bars into the space in between the outer tube and inner tube and the ring may be composed of two or more layers of patterned or clear glass rods or bars.

The details of various embodiments of the invention are set forth in the accompanying drawings and the description below. Numerous other features and advantages of the invention will be apparent from the description, the drawings, and the claims.

### DESCRIPTION OF THE DRAWINGS

FIG. 1 is a drawing of a glass tube with both ends left open.

FIG. 2 is a drawing of a glass tube which has one end sealed closed and the other end flared outward.

FIG. 3 is a side view of a glass rod with a helix of a colored glass running through its length, known in the glass art industry as a twisted glass cane, or a Zanfirico cane.

FIG. 3A is a cross-sectional view of the glass rod of FIG. 3 taken along line 3A-3A in FIG. 3.

FIG. 4 is a side view of a glass rod with four lines of colored glass even spaced around the perimeter of the glass rod, wherein the glass has been twisted to create a spiral effect of the colored glass, known in the glass art industry as a twisted glass cane, or a Zanfirico cane.

FIG. 4A is a cross-sectional view of the glass rod of FIG. 4 taken along line 4A-4A in FIG. 4.

FIG. 5 is a side view of a glass rod with three closely spaced lines of colored glasses and a wide strip of colored glass diametrically opposed to the three lines of color, wherein the glass has been twisted to produce a rod with a spiral or helical appearance, known in the glass art industry as a twisted glass cane, or a Zanfirico cane.

FIG. 5A is a cross-sectional view of the glass rod of FIG. 5 taken along line 5A-5A in FIG. 5.

FIG. 6 is a side view of a glass rod in which three lines of colored glass are closely spaced and the glass has been twisted to produce a glass rod with colored glass spiraling around its perimeter, known in the glass art industry as a twisted glass cane, or a Zanfirico cane.

FIG. 6A is a cross-sectional view of the glass rod of FIG. 6 taken along line 6A-6A in FIG. 6.

FIG. 7 is a side view of a glass rod that has no patterns or lines of colored glasses, but has specific optical or chemical properties, or that may just be uniform in color, or may be just clear glass.

FIG. 7A is a cross-sectional view of the glass rod of FIG. 7 taken along line 7A-7A in FIG. 7.

FIG. 8 is a side view of a bar of glass that has no patterns of colored glass, but has specific optical or chemical properties, or that may just be uniform in color, or may be just clear glass.

FIG. 8A is a cross-sectional view of the glass rod of FIG. 8 taken along line 8A-8A in FIG. 8.

FIG. 9 is a side view of the glass tube of FIG. 1, with the glass tube of FIG. 2 placed within.

FIG. 10 is a side view of a component 59 formed when the glass tube of FIG. 2 is inserted into the glass tube of FIG. 1 and the point of contact between the flange of the glass tube of FIG. 2 and the open diameter glass tube of FIG. 1 have been sealed hermetically using glassblowing techniques, yielding a single piece of glass.

FIG. 10A is a cross-sectional view of the assembly of FIG. 10, demonstrating the concentric relation of the inner tube to the outer tube.

FIG. 11 is an isometric view of glass rods according to FIG. 3 and glass rods according to FIG. 5, in alternating order, inserted into the interstitial volume created when the tube of FIG. 2 is placed within the tube of FIG. 1.

FIG. 12 is an isometric view of an assembly created when an alternating layer of glass rods according to FIG. 3 and glass rods according to FIG. 5 are inserted into the interstitial volume of the component of FIG. 10.

FIG. 12A is a cross-sectional view of the assembly of FIG. 12 upon initial assembly, taken along line 12A-12A in FIG. 12.

FIG. 12B is a cross-sectional view of the assembly of FIG. 12 after the lamination process is complete and all of the rods and inner and outer tubes are sealed into one piece.

FIG. 13 is an isometric view of an assembly of FIG. 12 created when an alternating layer of glass rods according to FIG. 3 and glass rods according to FIG. 6 are inserted into the interstitial volume of the component of FIG. 10.

FIG. 13A is a cross-sectional view of the assembly of FIG. 13 upon initial assembly taken along line 13A-13A in FIG. 13.

FIG. 13B is a cross-sectional view of the assembly of FIG. 13 after the lamination process is complete (right lower) and all of the rods and inner and outer tubes are sealed into one piece.

FIG. 14 is an isometric view of an assembly created when a layer of glass rods according to FIG. 7 are inserted into the interstitial volume of the component of FIG. 10.

FIG. 14A is a cross-sectional view of the assembly of FIG. 14 upon initial assembly taken along line 14A-14A in FIG. 14.

FIG. 14B is a cross-sectional view of the assembly of FIG. 14 after the lamination process is complete and all of the rods and inner and outer tubes are sealed into one piece.

FIG. 15 is an isometric view of the glass tube of FIG. 9 in which glass bars according to FIG. 8 have been inserted into the interstitial volume of the glass tube.

FIG. 16 is an isometric view of an assembly created when a layer of glass bars according to FIG. 8 are inserted into the interstitial volume of the component of FIG. 10.

FIG. 16A is a cross-sectional view of the assembly of FIG. 16 upon initial assembly, taken along line 16A-16A in FIG. 16.

FIG. 16B is a cross-sectional view of the assembly of FIG. 16 after the lamination process is complete and all of the rods and inner and outer tubes are sealed into one piece.

FIG. 17 is a side view of an assembly created when an alternating layer of glass rods according to FIG. 3 and glass rods according to FIG. 6 are inserted into the interstitial volume of the component of FIG. 10.

FIG. 17A is a cross-sectional view of the assembly of FIG. 17 upon initial assembly, taken along line 17A-17A in FIG. 17.

FIG. 17B is a cross-sectional view of the assembly of FIG. 17 after the lamination process is complete and all of the rods and inner and outer tubes are sealed into one piece.

FIG. 18 is an exploded isometric view of the assembly of FIG. 17 with a coupling and reduction fitting for attaching the assembly of FIG. 17 to a vacuum source and to a draw tower.

FIG. 19 is an assembled isometric view of the assembly of FIG. 17 with the coupling and reduction fitting for attaching assembly FIG. 17 to a vacuum source and to a draw tower.

FIG. 20 is an isometric view of the assembly of FIG. 19, but with the hose clamps included and the coupling material not represented in a see-through manner.

FIG. 21 is an isometric view of the assembly of FIG. 20 with the bottom half of the assembly having been passed through a high-temperature furnace.

FIG. 22 is an isometric view of the half-consolidated assembly FIG. 21 within the high-temperature furnace of FIG. 33, wherein during the laminating (fusing) of the bottom half of the assembly, the rate the glass is fed into the furnace is equal to the output of the glass.

FIG. 23 is an isometric view of a half-consolidated assembly similar to the assembly of FIG. 21 within the high-temperature furnace of FIG. 33, wherein during the laminating (fusing) of the bottom of the assembly, the rate the glass is fed into the furnace is approximately 75% of the rate of the output of the glass.

FIG. 24 is an isometric view of the assembly of FIG. 21, illustrating how the glass consolidates while at a temperature above Tg (glass transition point) of the glass.

FIG. 25 is a drawing of a pedestal or stage mounted on a long rod with a portion of the rod protruding for stabilizing and supporting an assembly, such as the assembly of FIG. 20, as it exits or enters a high-temperature furnace, such as the furnace of FIG. 33.

FIG. 26 is a drawing of the component of FIG. 10 with the pedestal or stage of FIG. 25 partially inserted into the component.

FIG. 27 is a drawing of the component of FIG. 10 with the pedestal or stage of FIG. 25 fully inserted into the component and the bottom of the component resting on the stage or platform.

FIG. 28 is a drawing of the pedestal or stage of FIG. 25 fully inserted into the assembly of FIG. 20 with the bottom of the assembly resting on the platform.

FIG. 29 is a side view of a platform that is mounted on linear rails with a ball screw and electric motor that can be traversed vertically with precision in both rate of travel and distance.

FIG. 30 is a drawing of the platform of FIG. 29 mounted to a ridged structure, such as a wall, holding the glass assembly FIG. 21 within the furnace of FIG. 33 with the bottom of the assembly of FIG. 21 supported by the pedestal or stage and rod of FIG. 25 supporting the bottom of the glass assembly as it is raised or lowered, the rate that the rod is moving being equal to the rate that the platform is moving.

FIG. 31 is a drawing of the platform of FIG. 29 mounted to a ridged structure, such as a wall, holding a glass assembly similar to the assembly of FIG. 21 within the furnace of FIG. 33 with the bottom of the glass assembly supported by the pedestal or stage and rod of FIG. 25 supporting the bottom of the glass assembly as it is raised or lowered, the rate that the rod is moving being 125% of the rate that the platform is moving.

FIG. 32 is a drawing of the platform, glass assembly, furnace, and pedestal or stage and rod of FIG. 31 but with the furnace cutaway so that the reduction of diameter of the assembly can be seen within the furnace.

FIG. 33 is drawing of a high-temperature furnace which is able to achieve temperatures (800-1000 deg C. for low-thermal-expansion borosilicate glass) above the glass transition temperature.

FIG. 34 is an isometric view of an assembly created when an alternating layer of glass rods according to FIG. 3 and glass rods according to FIG. 6 are inserted into the interstitial volume of the component of FIG. 10 and pieces of sacrificial glass tubing are placed on either ends of the rods.

FIG. 35 is an isometric view of a section of a finished laminated tube which incorporated rods according to FIG. 3 and rods according to FIG. 5 within the component of FIG. 10 during the drawing (consolidating or laminating) process.

FIG. 36 is an isometric view of a section of a finished laminated tube which incorporated rods according to FIG. 3 and rods according to FIG. 6 within the component of FIG. 10 during the drawing (consolidating or laminating) process.

FIG. 37 is a side view of a section of a finished laminated tube which incorporated rods according to FIG. 3 and rods according to FIG. 6 within the component of FIG. 10 during the drawing (consolidating or laminating) process.

FIG. 38 is an end view of a section of finished laminated tube in which the glass rods that were inserted within the component of FIG. 10 had a layer of glass on them that was identical to the glass used for tube of FIG. 1 and the tube of FIG. 2.

FIG. 39 is an end view of a section of finished laminated tube in which glass rods according to FIG. 7 that were inserted within the component of FIG. 10 had no differing external layer of glass.

FIG. 40 is an end view of a section of finished laminated tube, in which glass rods according to FIG. 7, which were inserted within the component of FIG. 10, are the same glass type as the component.

FIG. 41 is a drawing of rods according to FIG. 7 inserted within the component of FIG. 10, the rods being secured to the top of the component by means of wires.

FIG. 42 is a drawing of rods according to FIG. 7 inserted within the component of FIG. 10, the rods being secured to the top of the component by means of wires and the wires being secured by being bent over the top of the tube of the component and the coupling being slid over the end of the component trapping the wires and holding them securely.

FIG. 43 is a cross-sectional view of a preform in which the space between the tube of FIG. 1 and the tube of FIG. 2 has two or more layers of rods according to FIG. 7 nested in between.

FIG. 44 is a cross-sectional transverse view of a laminated tube in which rods according to FIG. 7 or bars according to FIG. 8, used within the component of FIG. 10, have a higher index of refraction than the tubes of FIG. 1 and FIG. 2 used to manufacture the component.

FIG. 45 is a cross-sectional longitudinal view of the laminated tube FIG. 44.

FIG. 46 is a cross-sectional longitudinal view of the laminated tube FIG. 44, showing light (λ) total internally reflecting (wave guiding) down the length of laminated tube FIG. 44.

Identical parts are indicated by the same reference numerals.

### DETAILED DESCRIPTION

The present invention provides an alternative method of producing glass tubing which involves inserting a smaller glass tube within a larger glass tube and filling the space which is formed between the smaller and larger tube with colored, patterned or clear glass rods or bars. On one end of this assembly, the end of the inner tube and end of the outer tube are sealed together using traditional glassblowing technique to form a seal known traditionally as a Dewar seal. The opposing end of the inner tube is sealed closed prior to assembly, hence upon creation of the Dewar seal, a hermetic chamber is created between the inner tube and outer tube in which the colored, patterned or clear glass rods or bars are nested. The assembly consisting of the inner tube and outer tube with the colored, patterned or clear glass rods or bars nested in between is fed into a high-temperature furnace which maintains a temperature above the glass transition temperature (Tg) of all of the glasses incorporated in the assembly. While the assembly is fed into or placed within a high-temperature furnace, vacuum is being pulled on the chamber (volume) in between the inner tube and outer tube in which the colored, patterned or clear glass rods or bars are nested and held captive. As the glass softens the outer tube collapses inward and makes contact with the colored, patterned or clear glass rods or bars, collapsing and squishing them against each other, and as the heat propagates inward, softens the inner glass tube which also expands outward towards the colored, patterned or clear glass rods or bars also making contact with them, as the outer tube did. As the two layers of tubing and colored, patterned or clear glass rods or bars trapped in between are passed through the high-temperature furnace and all gasses and air are continuously evacuated from this space, the glass consolidates into one piece with the colored, patterned or clear glass rods or bars fusing to each other and the inner and outer tubes fusing to them.

The product of this process is a laminated tube consisting of an inner layer and outer layer of glass and a central layer which is composed of whatever the colored, patterned or clear glass rods or bars were that were placed in between the inner and outer tube at the start of the process.

The feeding of the assembly into the high-temperature furnace to accomplish the laminating process is done vertically as it eliminates the need to rotate the hot glass to keep it on a central axis (as glassblowers have to do when heating a piece of glass on a lathe). The laminating process is typically done by lowering the assembly towards the force of gravity into and through the high-temperature furnace; however, it is alternatively possible to pull the assembly upward to accomplish the same result. The bottom of the assembly is supported by a platform or pedestal that is raised or lowered at a controlled rate which may be equal to or some fraction or factor of the rate that the assembly is fed into the furnace. The platform or pedestal prevents the bottom of the glass assembly from free falling under the force of gravity when it is heated above the glass transition temperature. In an instance when the assembly is lowered or raised at a rate equal to the rate that the supporting platform or pedestal is raised or lowered, there will be only a minor reduction in outside diameter of the assembly upon consolidation and fusing of the glass layers and as the lamination process completes. The minor reduction in diameter is the result of the outer tube collapsing inward onto the colored, patterned or clear glass rods or bars contained within. If a rate differential is purposely implemented between the supporting platform or pedestal and the assembly as it is passed through the furnace, an effect of stretching the glass can be produced, further reducing the outside diameter of the final laminated glass tube. It is also possible that during the process, air or gas can be fed into the central volume of the glass assembly to expand the laminated tube during formation and to increase its diameter in a controlled manner.

By using colored or patterned glass rods or bars, a tube which is uniform in color or highly ornate with a structured pattern or intentional aesthetic properties can be created.

The space between the inner and outer tube is carefully optimized by selecting inner and outer tubes of a specific size. A possible outer diameter glass tube size would be a tube with a 41 mm diameter and a 2 mm wall thickness. The inner tube would have a 22 mm diameter. This leaves 15 mm of free space between the inner diameter of the large tube and the outer diameter of the inner tube. For an application where the laminated tube is going to be used for glass art, the colored, patterned or clear glass rods or bars which will be used will be colored low-thermal-expansion borosilicate glass rods that are typically 7 mm in diameter. A total of thirteen of these colored glass rods will fit in between the inner and outer tubes of the sizes mentioned in this paragraph. There will be a little bit of looseness which is important because there is some dimensional variation of all of the glass used, and if there is not a little extra room, the colored rods may not fit.

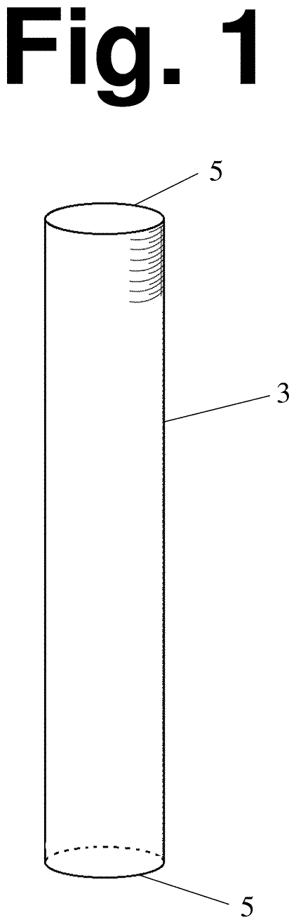

FIG. 1 illustrates a glass cylinder 3 with both ends 5 left open. Glass cylinder 3, which is also referred to as a tube, can be clear glass or colored or may be made of an acid soluble glass, a traditional chemically durable glass, or a glass with specific optical properties. In certain embodiments, glass cylinder 3 may have a diameter between 14 millimeters and 280 millimeters and a length of between 100 millimeters and 3000 millimeters.

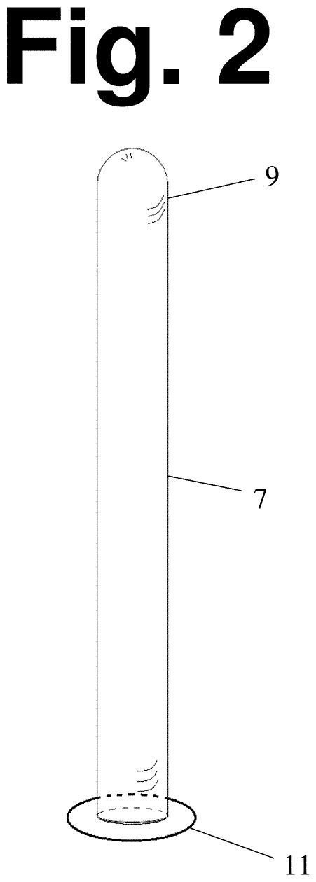

FIG. 2 is a drawing of a glass cylinder 7 with one end 9 sealed closed and one end 11 flared outward. Glass cylinder 7, which is also referred to as a tube, can be clear glass or colored or may be made of an acid soluble glass, a traditional chemically durable glass, or a glass with specific optical properties. In certain embodiments, glass cylinder 7 may have a diameter between 4 millimeters and 250 millimeters and a length of between 100 millimeters and 3000 millimeters.

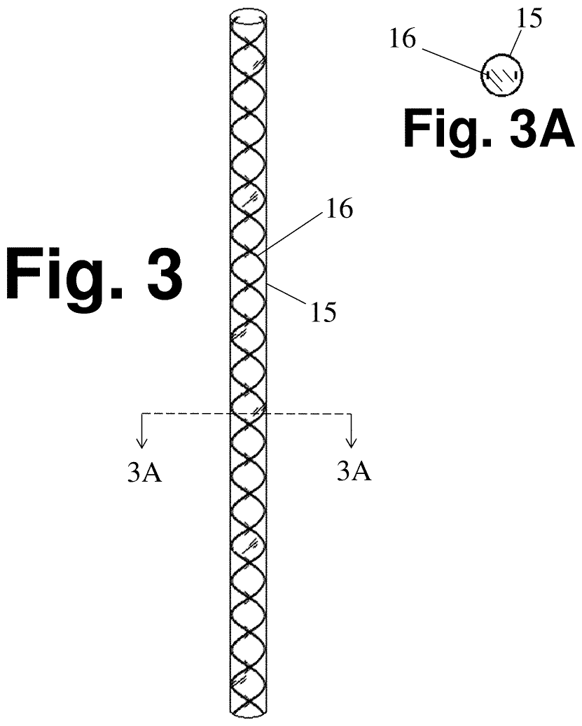

FIGS. 3 and 3A illustrate a glass rod 15 with a helix 16 of a colored glass running through its length, known in the glass art industry as a twisted glass cane, or a Zanfirico cane. In certain embodiments, the glass rod may have a diameter between 2 millimeters and 80 millimeters.

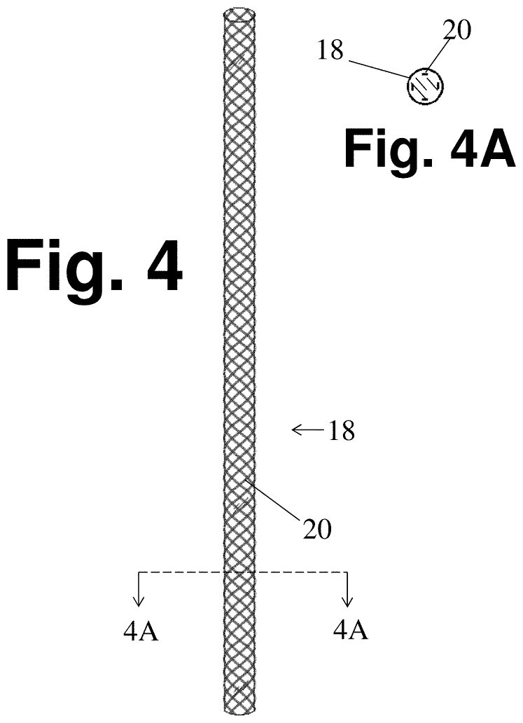

FIGS. 4 and 4A illustrate a glass rod 18 with four lines 20 of colored glass even spaced around the perimeter of the glass rod and the glass has been twisted to create a spiral effect of the colored glass, known in the glass art industry as a twisted glass cane, or a Zanfirico cane. In certain embodiments, the glass rod may have a diameter between 2 millimeters and 80 millimeters.

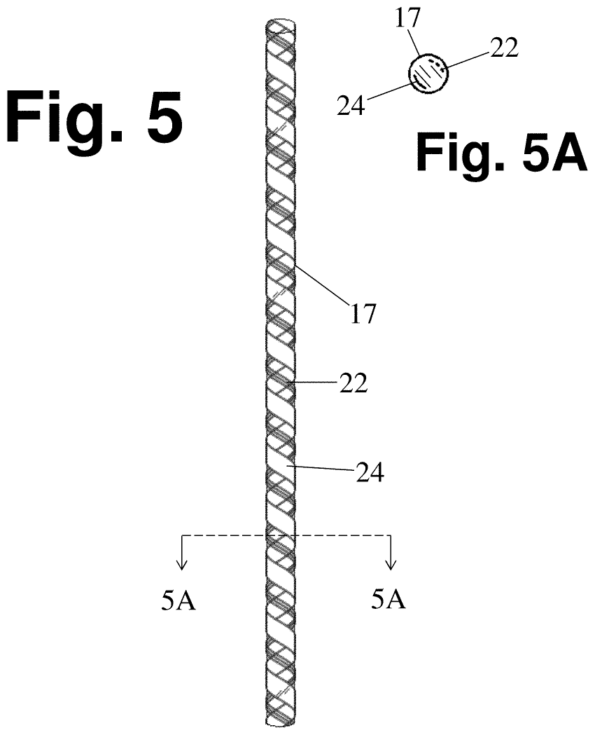

FIGS. 5 and 5A illustrate a glass rod 17 with three closely spaced lines 22 of colored glasses and a wide strip 24 of colored glass diametrically opposed to the three lines of color and the glass has been twisted to produce a rod with a spiral or helical appearance, known in the glass art industry as a twisted glass cane, or a Zanfirico cane. In certain embodiments, the glass rod may have a diameter between 2 millimeters and 80 millimeters.

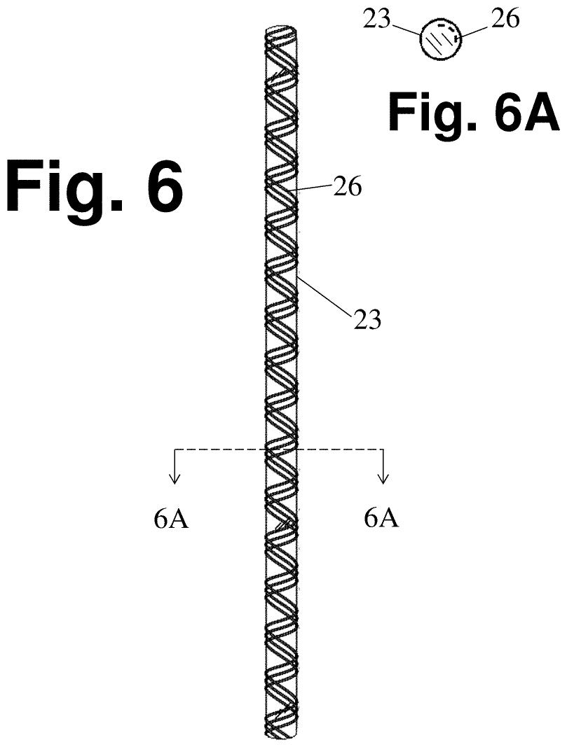

FIGS. 6 and 6A illustrate a glass rod 23 in which three lines 26 of colored glass are closely spaced and the glass has been twisted to produce a glass rod with colored glass spiraling around its perimeter, known in the glass art industry as a twisted glass cane, or a Zanfirico cane. In certain embodiments, the glass rod may have a diameter between 2 millimeters and 80 millimeters.

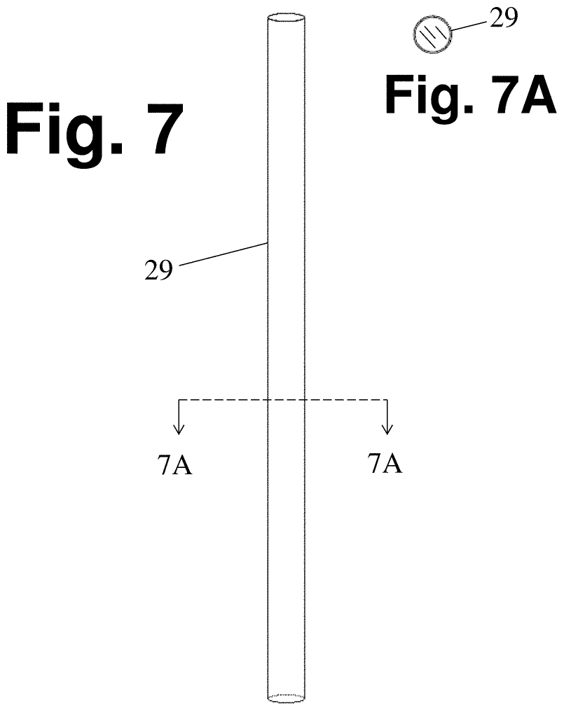

FIGS. 7 and 7A illustrate a glass rod 29 that has no patterns or lines of colored glasses. Glass rod 29, which is also referred to as a cane, can be clear glass or colored or may be made of an acid soluble glass or a traditional chemically durable glass or may have a tuned index of refraction or other specific optical property. In certain embodiments, the glass rod may have a diameter between 2 millimeters and 80 millimeters.

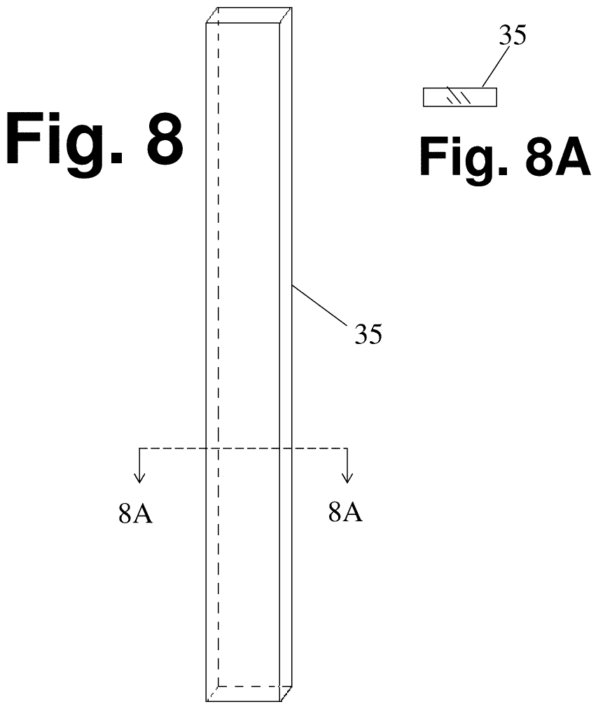

FIGS. 8 and 8A illustrate a glass bar 31 that has no patterns or lines of colored glasses. Glass bar 31, which is also referred to as a glass strip, can be clear glass or colored or may be made of an acid soluble glass or a traditional chemically durable glass or may have a tuned index of refraction or other specific optical property. In certain embodiments, the glass bar may have a width and/or thickness of between 2 millimeters and 80 millimeters.

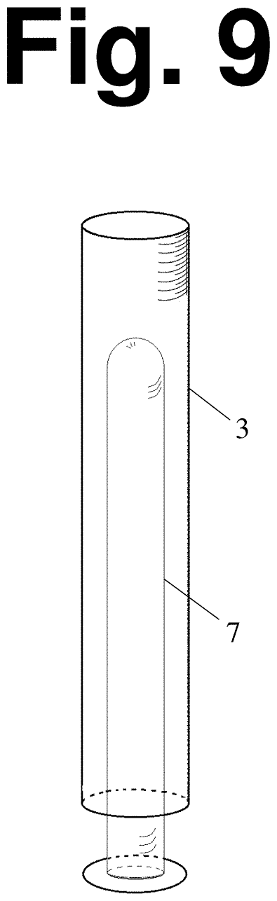

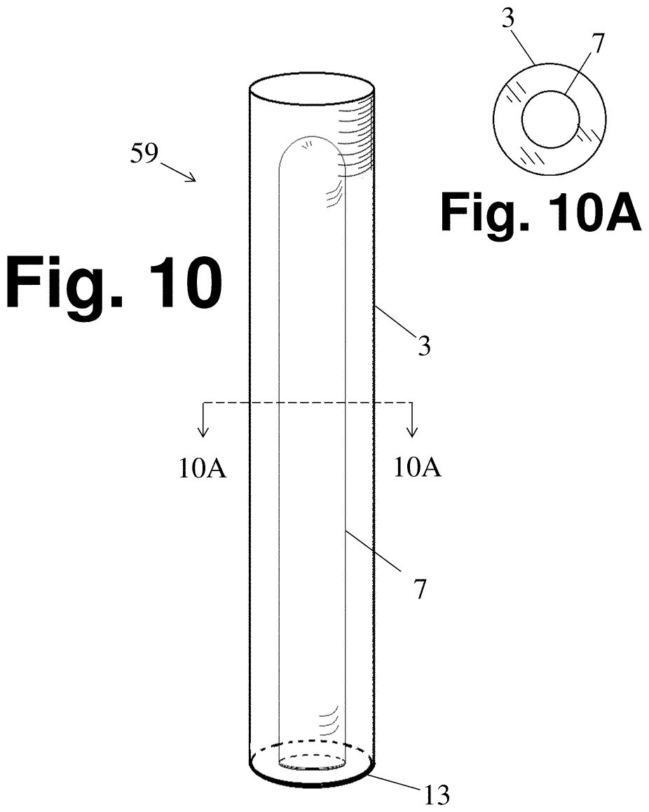

FIG. 9 shows glass cylinder 7 partially inserted within glass cylinder 3 FIGS. 10 and 10A illustrate a glass cylinder 7 completely inserted within glass cylinder 3. The flared end 11 of glass cylinder 7 is sealed by seal 13 to open end 5 of glass cylinder 3 by means of traditional glassblowing technique. The This type of seal 13 is classically known as a Dewar seal.

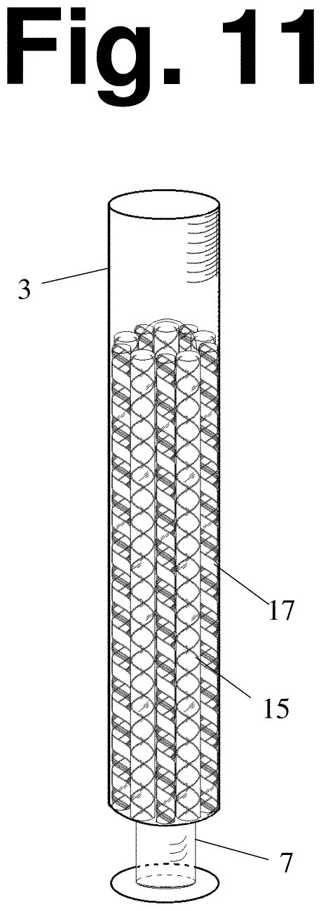

FIG. 11 shows glass cylinder 7 partially inserted within glass cylinder 3 with glass rods 15 and glass rods 17 inserted in an alternating order within the space in between glass cylinder 7 and glass cylinder 3

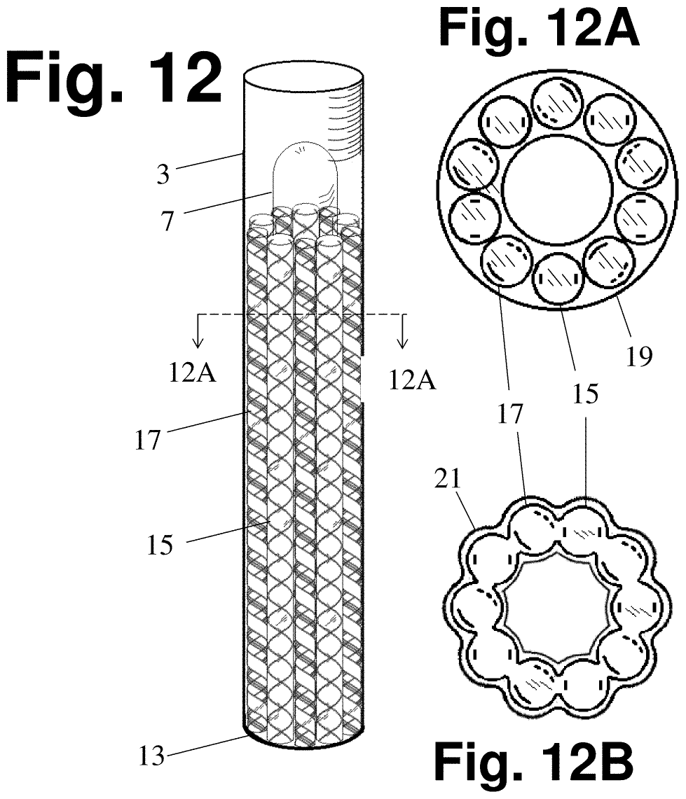

FIG. 12 shows glass cylinder 7 fully inserted within glass cylinder 3 and sealed by seal 13 with glass rods 15 and glass rods 17 inserted in an alternating order within the space in between glass cylinder 7 and glass cylinder 3. FIG. 12A is a cross sectional representation of the assembly 19 of FIG. 12 before the lamination process is executed. FIG. 12B is a cross sectional representation of FIG. 12 after the lamination (sealing process) is complete and glass cylinder 3, glass cylinder 7, glass rods 15 and glass rods 17 are all sealed into one piece of glass to form assembly 21.

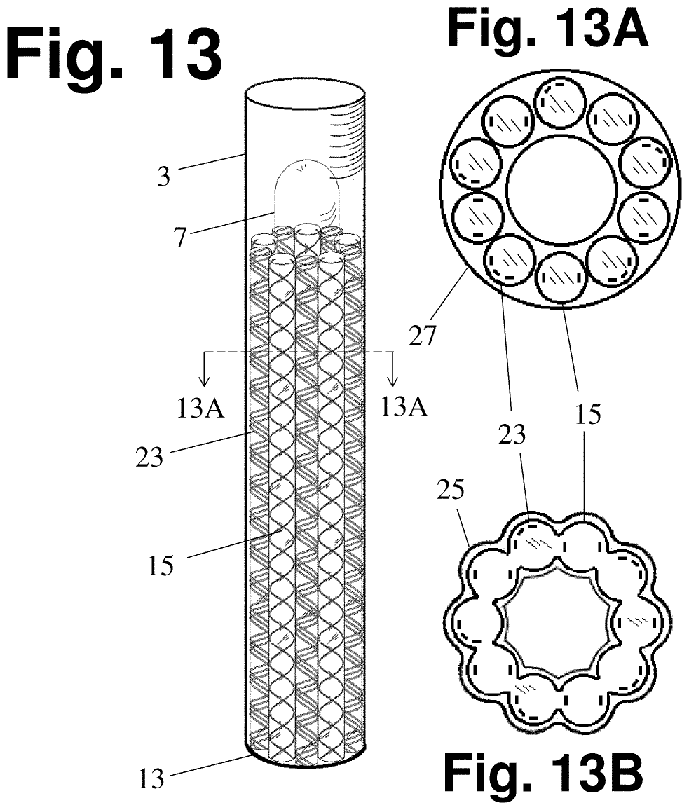

FIG. 13 shows glass cylinder 7 fully inserted within glass cylinder 3 and sealed by seal 13 with glass rods 15 and glass rods 23 inserted in an alternating order within the space in between glass cylinder 7 and glass cylinder 3. FIG. 13A is a cross sectional representation of the assembly 27 of FIG. 13 before the lamination process is executed. FIG. 13B is a cross sectional representation of FIG. 13 after the lamination (sealing process) is complete and glass cylinder 3, glass cylinder 7, glass rods 15 and glass rods 23 are all sealed into one piece of glass to form assembly 25.

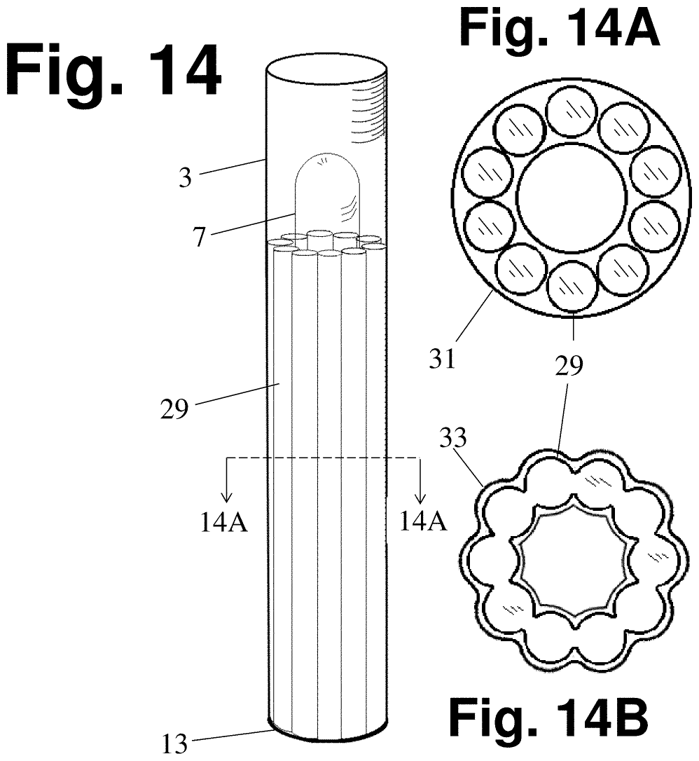

FIG. 14 shows glass cylinder 7 fully inserted within glass cylinder 3 and sealed by seal 13 with glass rods 29 inserted within the space in between glass cylinder 7 and glass cylinder 3. FIG. 14A is a cross sectional representation of the assembly 31 of FIG. 14 before the lamination process is executed. FIG. 14B is a cross sectional representation of FIG. 14 after the lamination (sealing process) is complete and glass cylinder 3, glass cylinder 7, and glass rods 29 are all sealed into one piece of glass to form assembly 33.

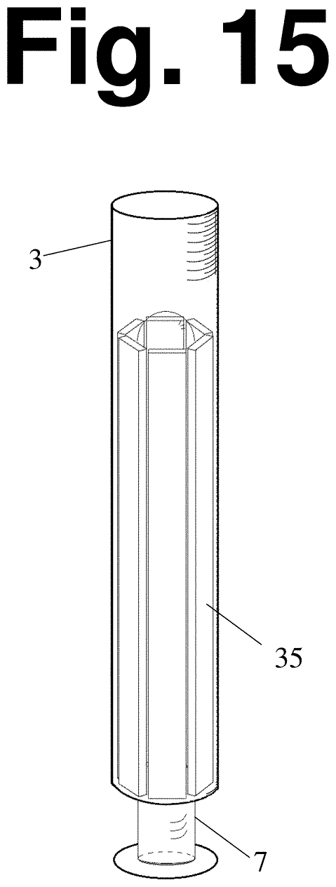

FIG. 15 shows glass cylinder 7 partially inserted within glass cylinder 3 with glass bars 35 inserted within the space in between glass cylinder 7 and glass cylinder 3

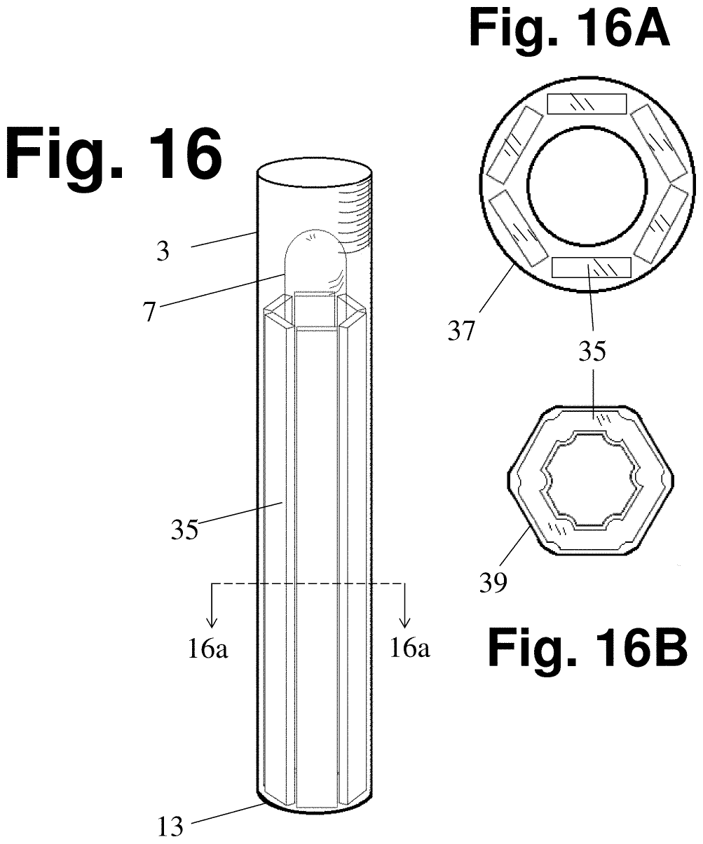

FIG. 16 shows glass cylinder 7 fully inserted within glass cylinder 3 and sealed by seal 13 with glass bars 35 inserted within the space in between glass cylinder 7 and glass cylinder 3. FIG. 16A is a cross sectional representation of the assembly 37 of FIG. 16 before the lamination process is executed. FIG. 16B is a cross sectional representation of FIG. 16 after the lamination (sealing process) is complete and glass cylinder 3, glass cylinder 7, and glass bars 35 are all sealed into one piece of glass to form assembly 39.

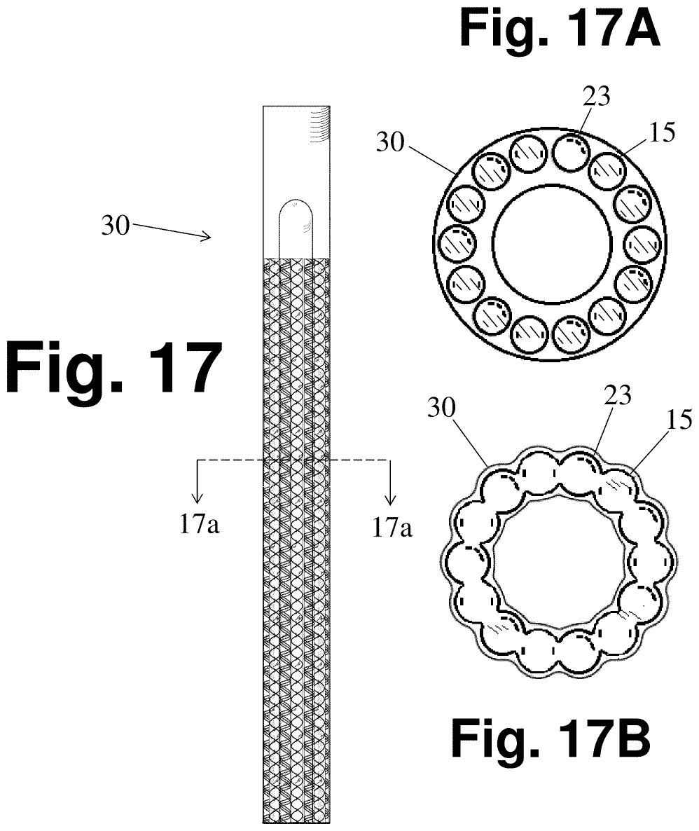

FIG. 17 is a side view of an assembly 30 created when an alternating layer of the glass rods 15 of FIG. 3 and the glass rods 23 of FIG. 6 are inserted into the interstitial volume of the component of FIG. 10. FIG. 17A is a cross-sectional view of assembly 30 upon initial assembly, and FIG. 17B is a cross-sectional view of assembly 30 after the lamination process is complete and all of the rods and inner and outer tubes are sealed into one piece.

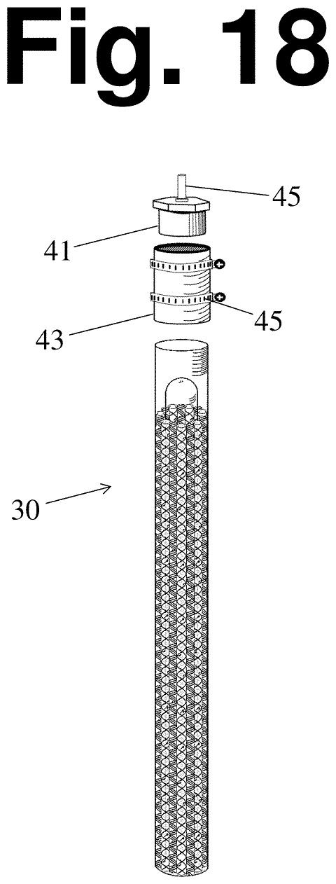

FIG. 18 is an exploded view of the glass assembly 30 of FIG. 17, along with a reduction fitting 41 and a coupling 43. Glass assembly 30 is coupled to reduction fitting 41, which has a nipple or connector 45 for attaching to a vacuum for the purpose of removing air or any residual gasses and reducing pressure within glass assembly 30 to a pressure less than the surrounding atmosphere outside of glass assembly 30. Coupling 43 is made of a piece of flexible heat-resistant material, such as automotive coolant tubing, that has low permeability to atmosphere and adequate physical strength to support glass assembly 30 during processing. Coupling 43, which may be a flexible piece of tubing, is secured to glass assembly 30 and reduction fitting 41 by hose clamps 47, which constrict coupling 43 securely around glass assembly 30 and reduction fitting 41 when tightened, so that glass assembly 30 cannot be pulled out of coupling 43 while glass assembly 30 is pulled downward during operation of the draw tower, and so that at least a partial hermetic seal is formed between glass assembly 30 and reduction fitting 41. Nipple 45 is hollow and allows the passing of liquid or gas into or out of the internal volume of glass assembly 30. Reduction fitting 41 is a pipe fitting that fits within the coupling and allows the preform to rotate, with nipple 45 being threaded into a vacuum-tight rotating union that functions as a vacuum swivel or rotating vacuum coupling that maintains a vacuum seal but can be rotated indefinitely. A rotation mechanism that can be used to impart rotation to a preform having such a reduction fitting is described in Kishinevski et al., U.S. Patent Publication 2018/0244558, the entire disclosure of which is hereby incorporated herein by reference.

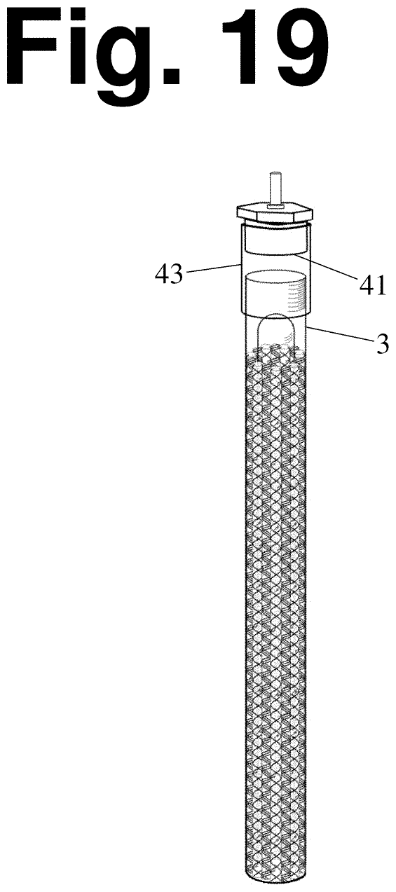

FIG. 19 is an assembled view of the components in FIG. 18 with the coupling details removed and depicted as transparent for clarity. The outside diameter of glass tube 3 and reduction fitting 41 are slightly smaller than the inside diameter of coupling 43. When fully assembled, the gap between glass tube 3 and the reduction fitting should be minimized so that minimum constriction of coupling 43 is required to secure it to tube 3 and reduction fitting 41. The open end of tube 3 must be mechanically coupled to reduction fitting 41, which is in turn attached to a rough vacuum pump, with a tight seal being provided by coupling 43 with very little seepage to enable a vacuum to be created within glass assembly 30. The components of FIG. 19 are assembled by sleeving the end of assembly 30 with the material of coupling 43 and inserting reduction fitting 41 within the other end of the material coupling 43, coupling 43 being represented schematically in a see-through manner so that glass tube 3 and reduction fitting 41 within are visible, and hose clamps not being included for simplicity of visual representation.

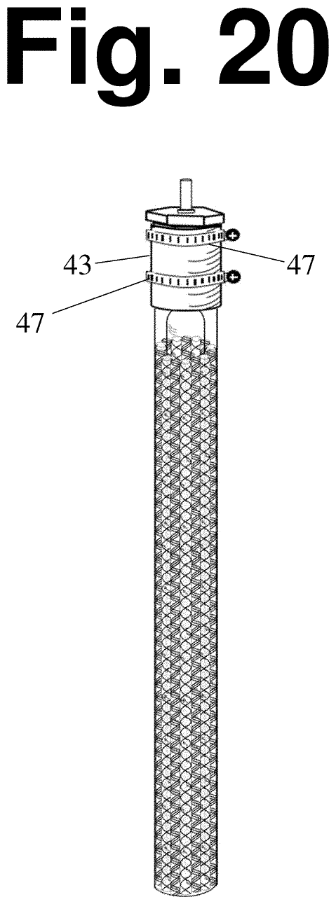

FIG. 20 is detailed assembled view of the components in FIG. 18, including the components of coupling 43, including hose clamps 47.

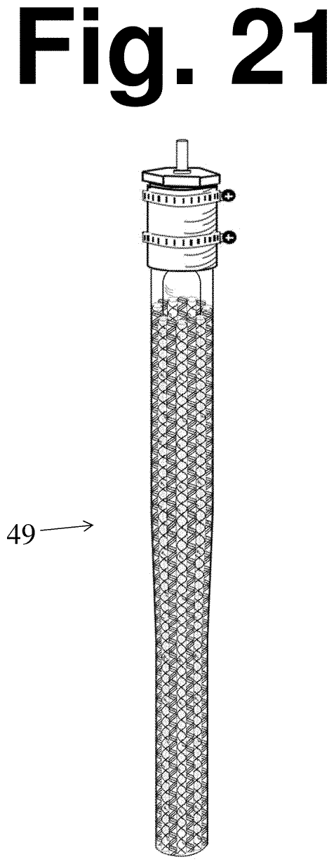

FIG. 21 is an isometric view of the assembly 49 of FIG. 20 with the bottom half of the assembly having been passed through a high-temperature furnace, and the inner tube of FIG. 2 and the outer tube of FIG. 1 with rods according to FIG. 3 and FIG. 6 in the process of being fused into one layer. The top half of assembly 49 has not yet been fused. The reduction of the diameter of the bottom half of assembly 49 is the result of the free volume within the assembly being eliminated during the glass consolidating into a solid layer.

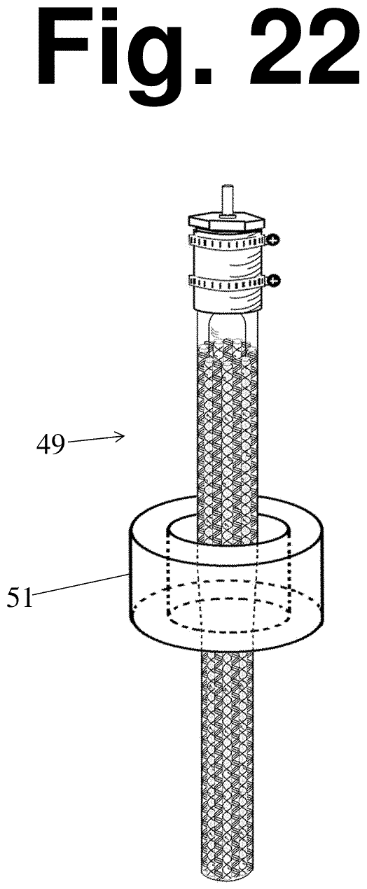

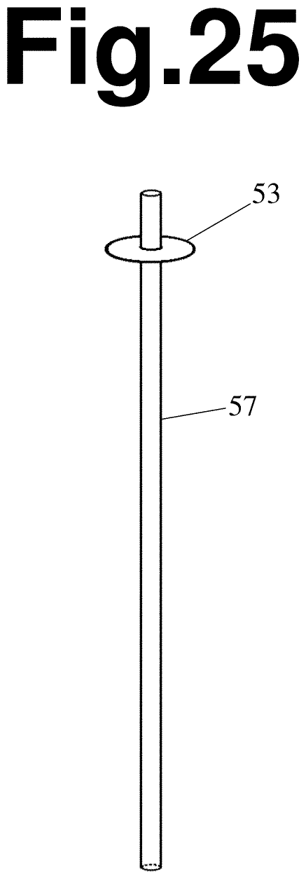

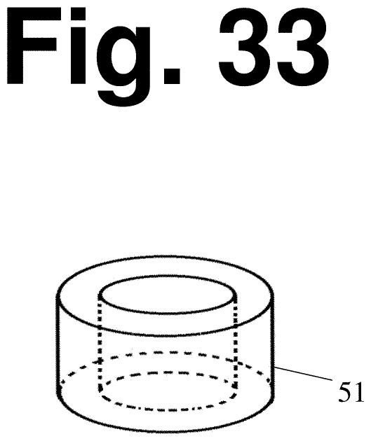

FIG. 22 is an isometric view of the half consolidated assembly 49 of FIG. 21 within the high-temperature furnace 51 of FIG. 33, wherein during the laminating (fusing) of the bottom half of assembly 49, the rate the glass is fed into furnace 51 is equal to the output of the glass (as controlled by pedestal 53 of FIG. 25) and the reduction of the diameter of the bottom half of assembly 49 is only the result of the free volume within the assembly being eliminated during the glass consolidating into a solid layer.

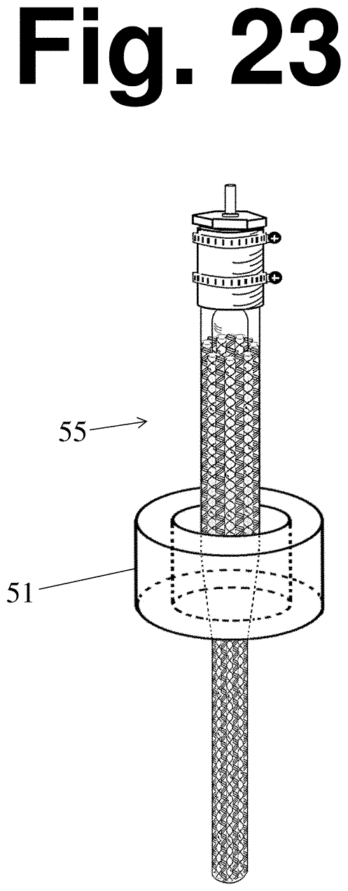

FIG. 23 is an isometric view of a half consolidated assembly 55 (similar to assembly 49 of FIG. 21) within the high-temperature furnace 51 of FIG. 33, wherein during the laminating (fusing) of the bottom of assembly 55, the rate the glass is fed into furnace 51 is approximately 75% of the rate of the output of the glass (as controlled by pedestal 53 of FIG. 25) and the reduction of the diameter of the bottom half of assembly 55 is the result of the free volume within the assembly being eliminated during the glass consolidating into a solid layer and an effective stretching effect caused by the glass being able to leave furnace 51 faster than it is fed into the furnace.

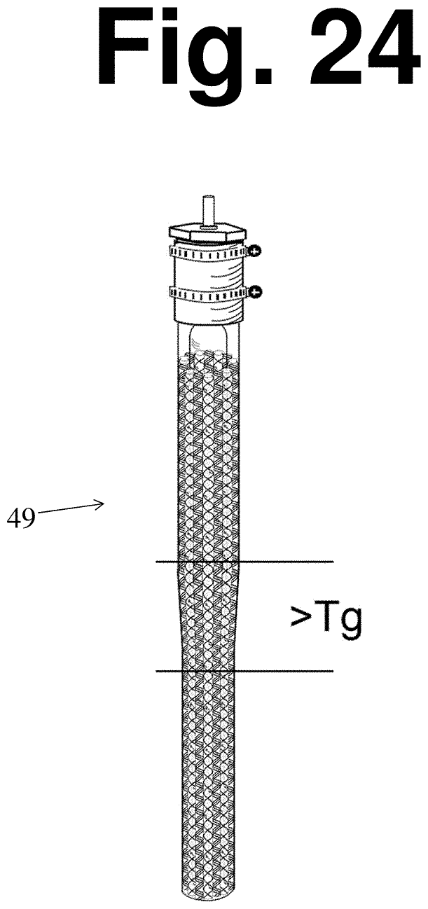

FIG. 24 is an isometric view of assembly 49 of FIG. 21, illustrating how the glass consolidates while at a temperature above Tg (glass transition point) of the glass.

FIG. 25 is a drawing of a pedestal or stage 53 mounted on a long rod 57 with a portion of the rod protruding for stabilizing and supporting an assembly, such as the assembly of FIG. 20, as it exits or enters a high-temperature furnace, such as furnace 51 of FIG. 33.

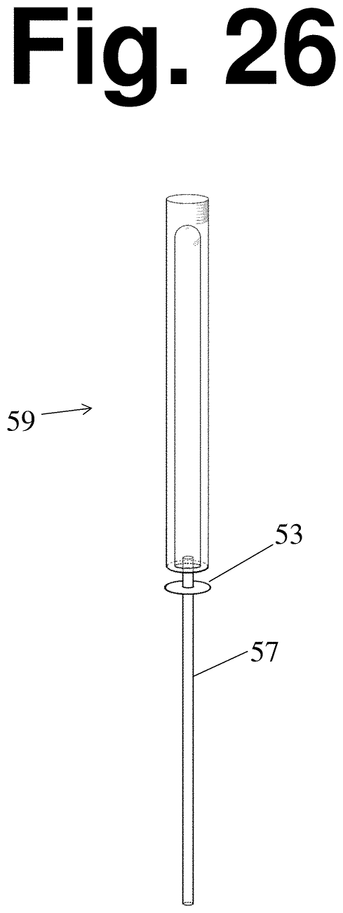

FIG. 26 is a drawing of the component 59 of FIG. 10 with the protruding portion of the rod 57 of the pedestal or stage 53 of FIG. 25 partially inserted into component 59.

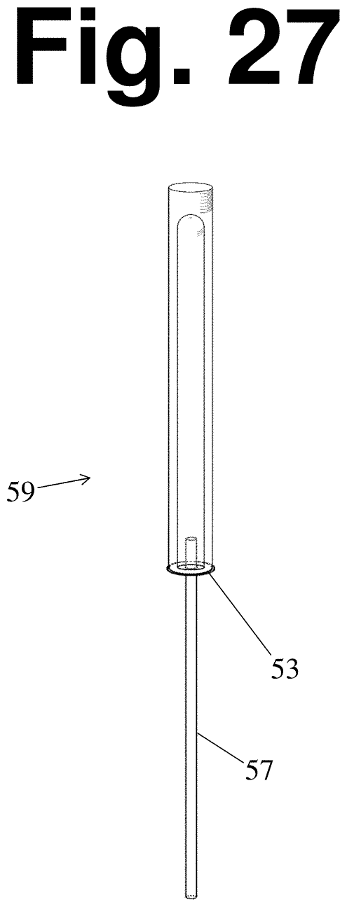

FIG. 27 is a drawing of the component 59 of FIG. 10 with the protruding portion of the rod 57 of the pedestal or stage 53 of FIG. 25 fully inserted into component 59 and the bottom of the component resting on the stage or platform 53.

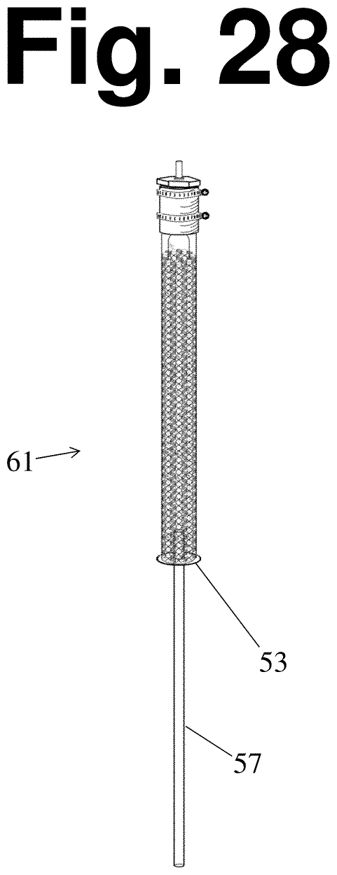

FIG. 28 is a drawing of the protruding portion of the rod 57 of pedestal or stage 53 of FIG. 25 fully inserted into the assembly 61 of FIG. 20 with the bottom of the assembly resting on platform 53.

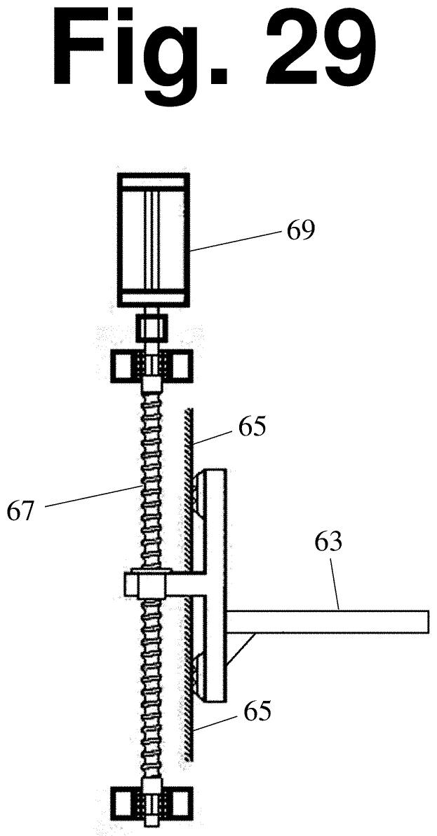

FIG. 29 is a side view of a platform 63 that is mounted on linear rails 65 with a ball screw 67 and electric motor 69 that can be traversed vertically with precision in both rate of travel and distance. The laminated glass assembly, such as is illustrated in FIG. 20, hangs from platform 63 as it is lowered or raised into the high-temperature furnace illustrated in FIG. 33.

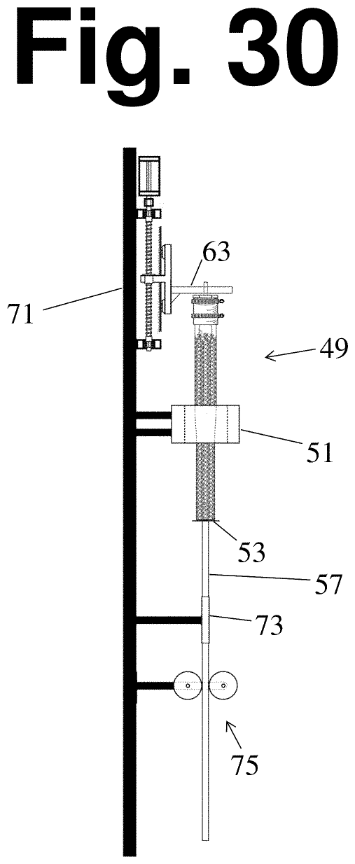

FIG. 30 is a drawing of platform 63 of FIG. 29 mounted to a ridged structure 71, such as a wall, holding the glass assembly 49 of FIG. 21 within the furnace 51 of FIG. 33 with the bottom of assembly of 49 supported by the pedestal or stage 53 and rod 57 of FIG. 25 supporting the bottom of glass assembly 49 as it is raised or lowered, the rate that rod 57 is moving being equal to the rate that platform 63 from which the glass is hanging s moving, so the only reduction in diameter of glass assembly 49 is due to the consolidation of layers of the glass only. Rod 57 is supported by a sleeve 73 such as a precision fitting tube which prevents lateral movement of pedestal or stage 53 and rod 57 and allows them to move only vertically with no ability to move side to side. Rod 57 is controlled in its rate of movement by a tractor mechanism 75 such as a pair of wheels in which rod 57 is constrained and the actuation of the wheels by a force such as an electric motor will cause rod 57 to raise or lower as the wheels are turned.

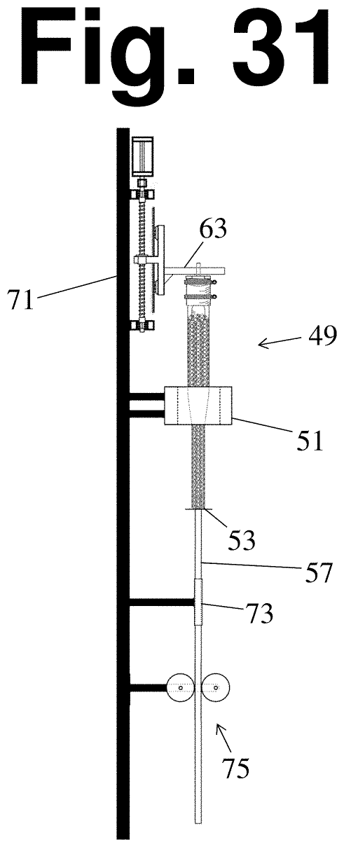

FIG. 31 is a drawing of the platform 63 of FIG. 29 mounted to a ridged structure, such as a wall, holding the glass assembly 49 of FIG. 21 within the furnace 51 of FIG. 33 with the bottom of glass assembly 49 supported by the pedestal or stage 53 and rod 57 of FIG. 25 supporting the bottom of glass assembly 49 as it is raised or lowered, the rate that rod 57 is moving being 125% of the rate that platform 63 from which the glass is hanging is moving, so the reduction in diameter of glass assembly 49 is due to the consolidation of layers of the glass and a stretching effect caused by rod 57 moving downward faster than platform 63 is moving downward, or if moving upward, rod 57 is moving 75% the speed of stage 63. Once again, rod 57 is supported by a sleeve 73 such as a precision fitting tube which prevents lateral movement of pedestal or stage 53 and rod 57 and allows them to move only vertically with no ability to move side to side. Rod 57 is controlled in its rate of movement by a tractor mechanism 75 such as a pair of wheels in which rod 57 is constrained and the actuation of the wheels by a force such as an electric motor will cause rod 57 to raise or lower as the wheels are turned.

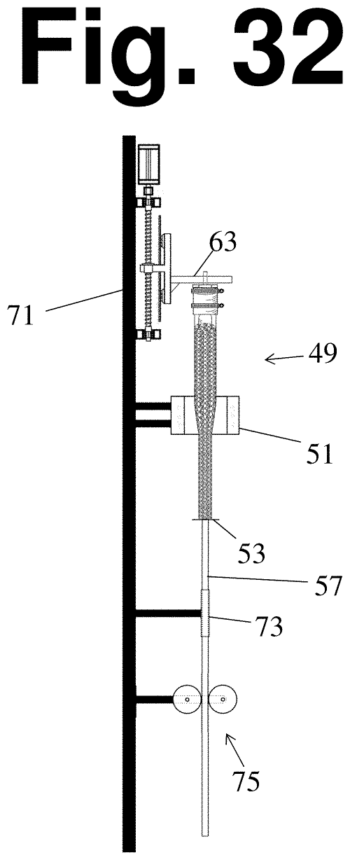

FIG. 32 is a drawing of platform 63, glass assembly 49, furnace 51, pedestal or stage 53 and rod 57 of FIG. 31 but with furnace 51 shown in cutaway so that the reduction of diameter of assembly 49 can be seen within furnace 51.

FIG. 33 is drawing of a high-temperature furnace 51, which is able to achieve temperatures (800-1000 deg C. for low-thermal-expansion borosilicate glass) above the glass transition temperature. The high-temperature furnace may be heated with a fuel-air for fuel-oxygen flame or it may be heated electrically using resistant heating elements such as nichrome wire or molybdenum disilicide heating elements.

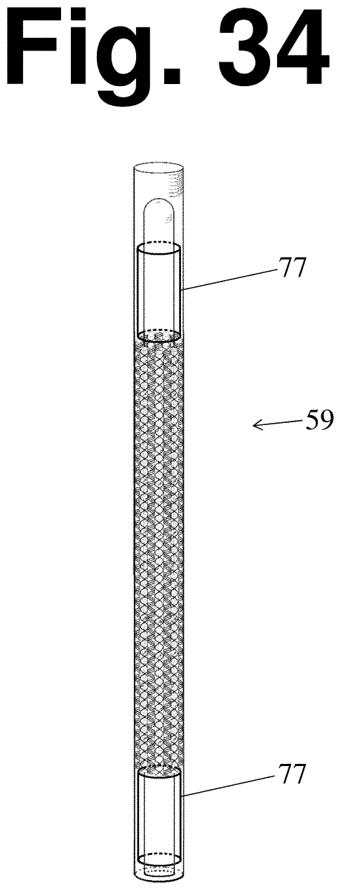

FIG. 34 is an isometric view of an assembly created when an alternating layer of glass rods according to FIG. 3 and glass rods according to FIG. 6 are inserted into the interstitial volume of the component 59 of FIG. 10 and pieces of sacrificial glass tubing 77 are placed on either ends of the rods. The sacrificial pieces of glass tubing allow for the lamination process to stabilize at the beginning and end without utilizing any of the rods of FIG. 3 and FIG. 6, which are expensive, and for which optimizing use thereof is desirable.

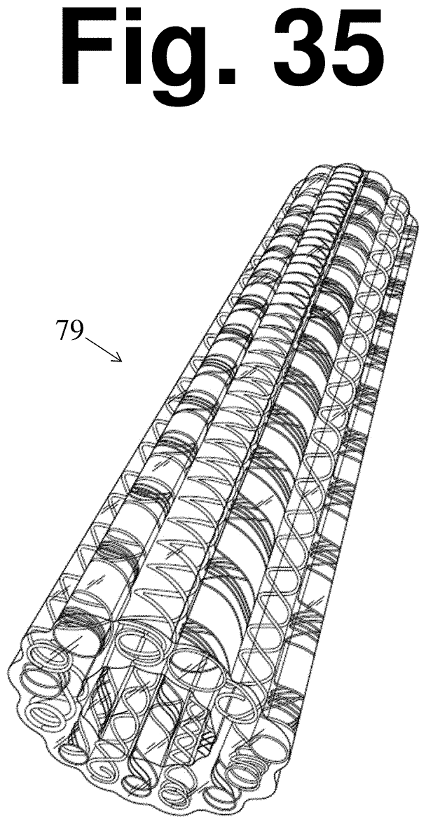

FIG. 35 is an isometric view of a section of a finished laminated tube 79 which incorporated rods according to FIG. 3 and rods according to FIG. 5 within the component of FIG. 10 during the drawing (consolidating or laminating) process.

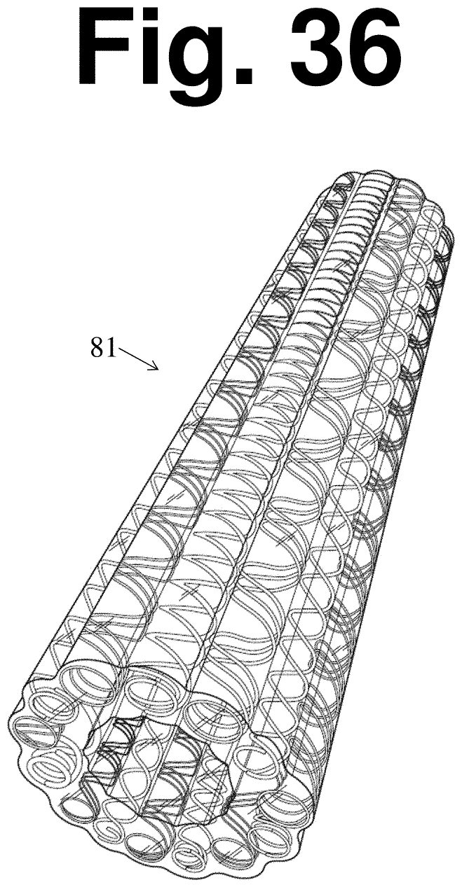

FIG. 36 is an isometric view of a section of a finished laminated tube 81 which incorporated rods according to FIG. 3 and rods according to FIG. 6 within the component of FIG. 10 during the drawing (consolidating or laminating) process.

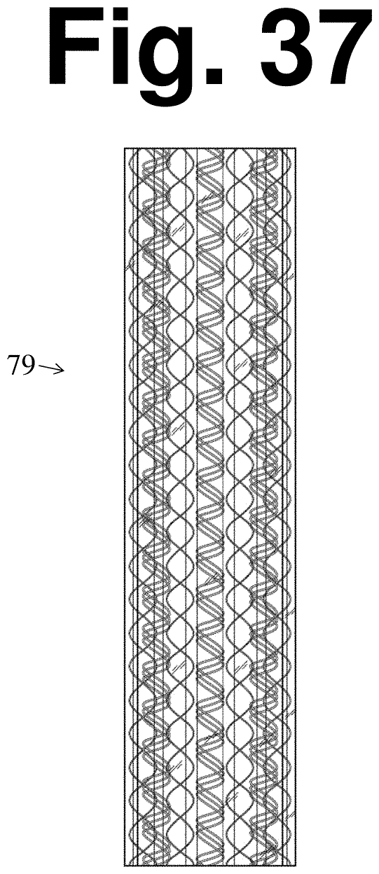

FIG. 37 is a side view of a section of the finished laminated tube 81 which incorporated rods according to FIG. 3 and rods according to FIG. 6 within the component of FIG. 10 during the drawing (consolidating or laminating) process.

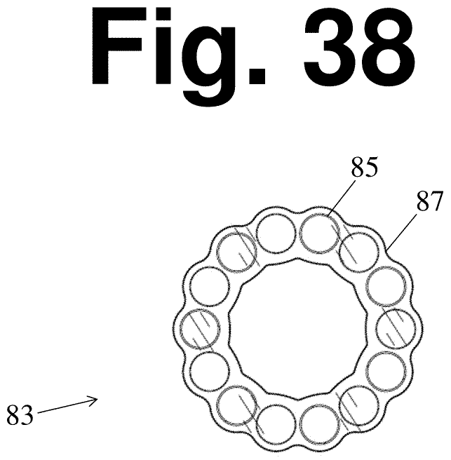

FIG. 38 is an end view of a section of finished laminated tube 83 in which the glass rods 85 that were inserted within the component of FIG. 10 had a layer of glass on them that was identical to the glass used for tube of FIG. 1 and the tube of FIG. 2. In this figure it can be seen that each rod 85 is separated by a boundary 87 of glass as the glass type that was within the rod layer is different from the glass that the layer on the rod was made out of.

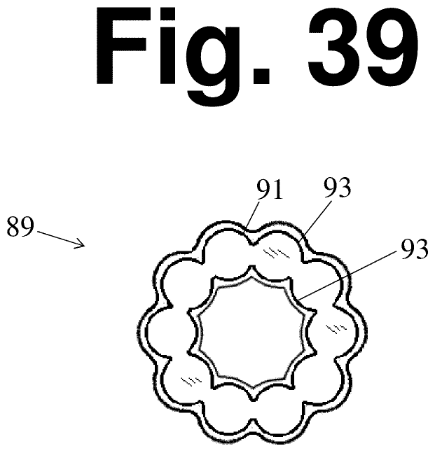

FIG. 39 is an end view of a section of finished laminated tube 89 in which glass rods according to FIG. 7 that were inserted within the component of FIG. 10 had no differing external layer of glass, but the rods are a different glass type than the glass used for the component and upon completion of the laminating process the rods fused together into one continuous section 91 with no boundary of different glass in between the rods, but an interface 93 exists between the fused rods and the inner and outer tubes of the component.

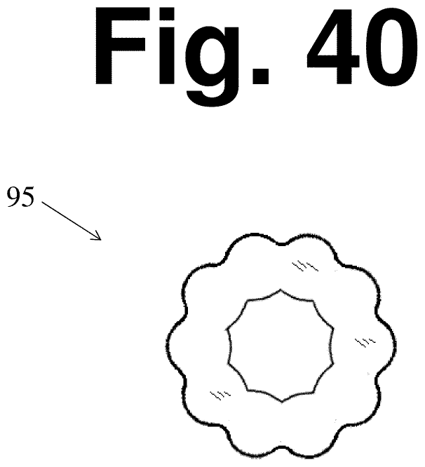

FIG. 40 is an end view of a section of finished laminated tube 95, in which glass rods according to FIG. 7, which were inserted within the component of FIG. 10, are the same glass type as the component, and upon completion of the lamination process, the inner tube, rods, and outer tube are fused into one continuous piece of glass with no visible boundaries or interfaces.

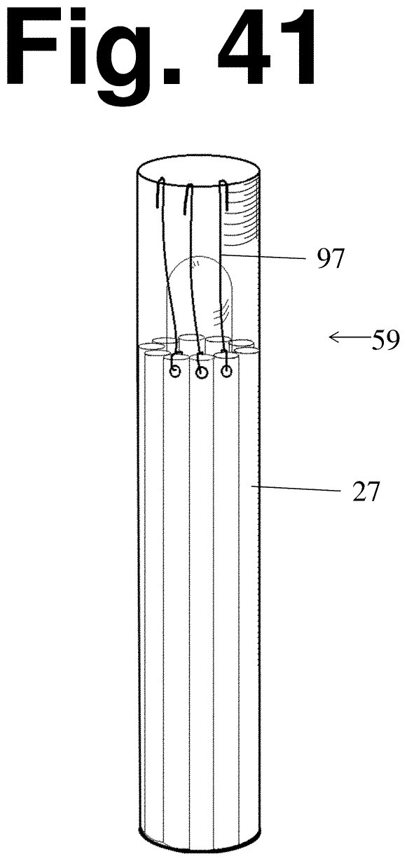

FIG. 41 is a drawing of rods 27 according to FIG. 7 inserted within the component 59 of FIG. 10, rods 27 being secured to the top of component 59 by means of wires 97.

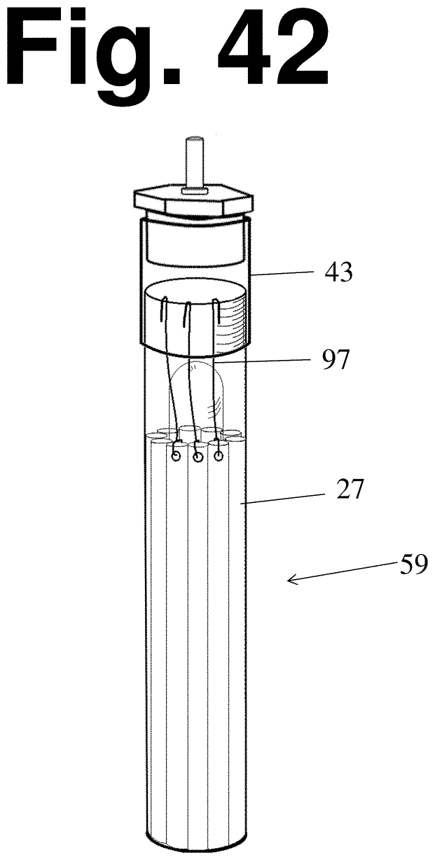

FIG. 42 is a drawing of rods 27 according to FIG. 7 inserted within the component 59 of FIG. 10, rods 27 being secured to the top of component 59 by means of wires 97 and the wires being secured by being bent over the top of tube 3 of component 59 and coupling 43 being slid over the end of component 59 trapping wires 97 and holding them securely.

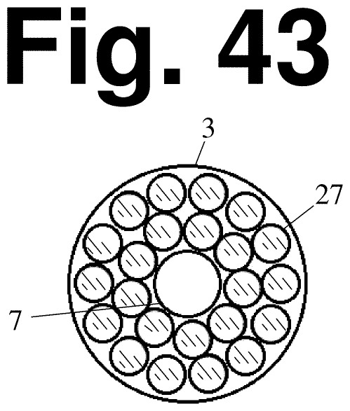

FIG. 43 is a cross-sectional view of a preform in which the space between the tube 3 of FIG. 1 and the tube 7 of FIG. 2 has two or more layers of rods 27 according to FIG. 7 nested in between. In this figure tube 7 is located concentric to tube 3 and rods 27 are occupying the interstitial free volume.

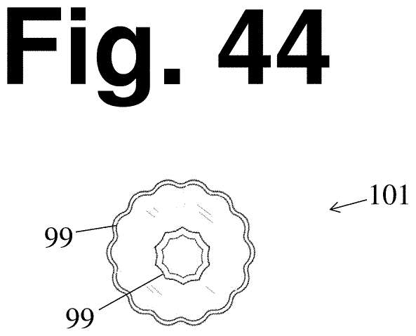

FIG. 44 is a cross-sectional transverse view of a laminated tube 101 in which rods according to FIG. 7 or bars according to FIG. 8, used within the component of FIG. 10, have a higher index of refraction than the tubes of FIG. 1 and FIG. 2 used to manufacture the component. The resulting laminated tube allows light to be introduced which will totally internally reflect (waveguide) in between the boundaries 99 between the layers of the former tube of FIG. 1 and tube of FIG. 2.

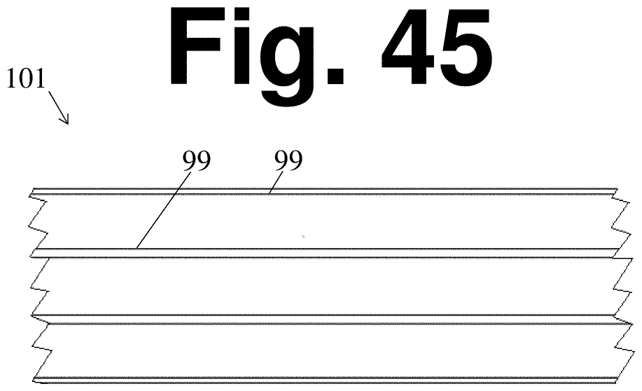

FIG. 45 is a cross-sectional longitudinal view of the laminated tube 101 of FIG. 44.

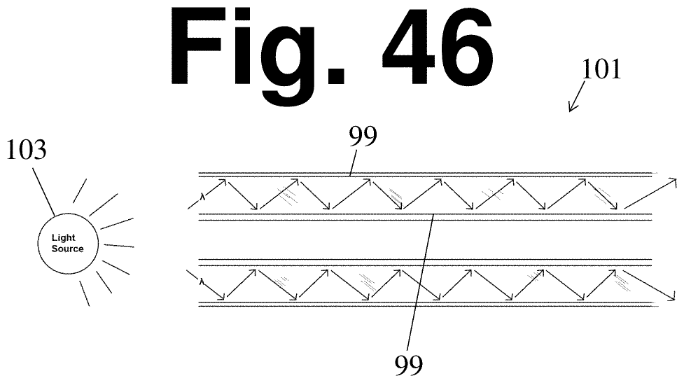

FIG. 46 is a cross-sectional longitudinal view of the laminated tube 101 of FIG. 44, showing light (λ) from light source 103 total internally reflecting (wave guiding) down the length of laminated tube 101.

What is claimed is:

1. A method of manufacturing a glass tube comprising:
nesting a smaller tube within a larger tube;
filling a space which is formed between the smaller and larger tube with colored, patterned, or clear glass rods or bars to form an assembly;
attaching the assembly to a linear motion mechanism;
using the linear motion mechanism to pass the assembly through a high-temperature furnace having a temperature above the glass transition temperature of the glasses used to build the assembly, causing the glasses to collapse towards each other once they reach a plastic state, and causing the outer tube and inner tube to seal against the colored, patterned, or clear glass rods or bars that were held captive.

2. A method in accordance with claim 1, further comprising, on one end of the assembly, sealing the inner tube to the outer tube before attaching the assembly to the linear motion mechanism, and wherein, on an opposite end of the assembly, the inner tube is closed.

3. A method in accordance with claim 1, further comprising applying a vacuum to the assembly while using the linear motion mechanism to pass the assembly through the high-temperature furnace.

4. A method in accordance with claim 1, wherein the assembly is passed through the high-temperature furnace vertically.

5. A method in accordance with claim 1, wherein the linear motion mechanism is a linear slide mechanism of a draw tower.

6. A method in accordance with claim 1, wherein the linear motion mechanism passes the assembly through the high-temperature furnace at a controlled rate.

7. A method in accordance with claim 1, further comprising supporting a bottom of the assembly by a stage or pedestal while the assembly passes through the high-temperature furnace.

8. A method in accordance with claim 7, wherein supporting the bottom of the assembly by the stage or pedestal comprises inserting a finger that protrudes from the stage or pedestal into the bottom of the assembly.

9. A method in accordance with claim 7 further comprising raising or lowering the pedestal or stage at a controlled rate while the assembly passes through the high-temperature furnace.

10. A method in accordance with claim 7, comprising moving the stage or platform at a rate substantially equal to a rate at which the assembly is fed into the high-temperature furnace.

11. A method in accordance with claim 7, comprising moving the stage or platform at a rate substantially different from a rate at which the assembly is fed into the high-temperature furnace.

12. A method in accordance with claim 1, further comprising introducing or exhausting air or gas into the assembly while the assembly passes through the high-temperature furnace.

13. A method in accordance with claim 12, wherein the air or gas is introduced or exhausted through a rod or pole connected to a stage or pedestal that supports a bottom of the assembly.

14. A method in accordance with claim 1, comprising rotating one end of the assembly while resisting rotation of an opposite end of the assembly while passing the assembly through the high-temperature furnace.

15. A glass tube manufactured according to a method comprising:
nesting a smaller tube within a larger tube;
filling a space which is formed between the smaller and larger tube with colored, patterned, or clear glass rods or bars to form an assembly;
attaching the assembly to a linear motion mechanism;
using the linear motion mechanism to pass the assembly through a high-temperature furnace having a temperature above the glass transition temperature of the glasses used to build the assembly, causing the glasses to collapse towards each other once they reach a plastic state, and causing the outer tube and inner tube to seal against the colored, patterned, or clear glass rods or bars that were held captive;
whereby the glass tube produced by the method has dimensional uniformity as perceived visually throughout the glass tube.

16. A machine for manufacturing a glass tube, comprising:
a platform configured to hold a glass preform assembly;
a linear motion mechanism configured to raise or lower the platform at a controlled rate such that the preform assembly passes through a high-temperature furnace;
a stage or pedestal configured to support a bottom of the glass preform assembly as the glass preform assembly is heated to a plastic state by the high-temperature furnace; and
a mechanism configured to raise or lower the stage or pedestal at a controlled rate to control a rate of passage of the glass out of the high-temperature furnace.

17. A machine in accordance with claim 16, wherein the linear motion mechanism is a linear slide mechanism of a vertical draw tower.

18. A machine in accordance with claim 16, further comprising the high-temperature furnace through which the preform assembly passes.

19. A machine in accordance with claim 16, wherein the stage or pedestal is mounted on a hollow rod or pole to allow for introduction or exhaust of air or gasses for expanding or constricting a glass tube that is formed from the glass preform assembly.

20. A machine in accordance with claim 16, wherein the stage or pedestal has a finger protruding from the stage or pedestal that is configured to extend into the bottom of the glass preform assembly and into a hollow portion of the glass preform assembly, from which a glass tube is formed.
